(19) United States
(12) Patent Application Publication
(10) Pub. No.: US 2026/0055623 A1
(43) Pub. Date: Feb. 26, 2026

(54) SAFE-ACCESS FOCUS TRACK

(71) Applicant: Yale University, New Haven, CT (US)

(72) Inventor: Neil Mulligan, New Haven, CT (US)

(21) Appl. No.: 19/307,488

(22) Filed: Aug. 22, 2025

Related U.S. Application Data
(60) Provisional application No. 63/686,528, filed on Aug. 23, 2024.

(51) Int. Cl. E04G 3/28; A62B 35/00

(52) U.S. Cl. CPC E04G 3/28; A62B 35/0012; E04G 2003/283; E04G 2003/286

(57) ABSTRACT

A focus track system is disclosed. The system includes a track having a channel disposed along a length of the track. The system includes a first pulley assembly coupled to one end of the track and a second pulley assembly coupled to an opposite end of the track. The first pulley assembly and the second pulley assembly are aligned with one another. The system includes a carrier assembly operably coupled with the first pulley assembly and the second pulley assembly via a first line. The carrier assembly is configured to travel along the length of the channel. The system includes a focus chair operably coupled to the carrier assembly via a pulley assembly and a second line, such that the focus chair is configured to travel in a direction perpendicular to the length of the track.

### CROSS-REFERENCE TO RELATED APPLICATIONS

This application claims priority to U.S. Provisional Patent Application No. 63/686,528, filed on Aug. 23, 2024, incorporated herein by reference in its entirety.

### BACKGROUND

Focus track systems are typically used in the entertainment industry to traverse workers along a span to reach otherwise inaccessible lighting instruments or stage scenery. Generally, installing a typical focus track system is time-consuming. Often, the hardware used to connect the track to a counterweight system batten is unwieldy, installing the access ladder and fall protection systems requires working at height, and securing the arbor requires manufacturing custom rigging for each trim height needed. The track is typically accessed via wire rope ladder, which can be physically challenging to climb. Once at the proper height the operator must change fall protection systems and climb from the ladder into a bosun's chair. This maneuver requires both specialized training and a high tolerance for performing complicated physical maneuvers at height. To move horizontally, traditional systems require the operator to pull themselves along the track. This means that the operator must be at track height in order to traverse, necessitating the use of multiple tracks for different trim positions. This also means that in the case of an emergency the operator may be unable to move themselves into a safe position for rescue. If an emergency occurs in a location that is inaccessible from the ground, rescue in a typical focus track system may require both highly trained personnel and specialized equipment. In time-sensitive situations, accident location could mean the difference between life and death.

Thus, there is a need in the art for improved focus track systems. The present invention satisfies this need.

### SUMMARY

The present disclosure relates generally to focus track systems, and more particularly, to a focus track system that allows a worker to be positioned within a focus chair at ground height, to control ascent and descent of the focus chair, and to traverse the track of the focus system at any trim height.

In one or more aspects, the disclosed technology relates to a focus track system. The system includes a track having a channel disposed along a length of the track. The system includes a first pulley assembly coupled to one end of the track and a second pulley assembly coupled to an opposite end of the track. The first pulley assembly and the second pulley assembly are aligned with one another. The system includes a carrier assembly operably coupled with the first pulley assembly and the second pulley assembly via a first line. The carrier assembly is configured to travel along the length of the channel. The system includes a focus chair operably coupled to the carrier assembly via a pulley assembly and a second line, such that the focus chair is configured to travel in a direction perpendicular to the length of the track.

In one or more aspects, the disclosed technology relates to a focus track kit. The kit includes a track having a channel disposed along a length of the track. The kit includes a first pulley assembly configured to couple to one end of the track and a second pulley assembly configured to couple to an opposite end of the track. The first pulley assembly and the second pulley assembly are aligned with one another when coupled to the track. The kit includes a carrier assembly configured to operably couple with the first pulley assembly and the second pulley assembly via a first line. The carrier assembly is configured to travel along the length of the channel. The kit includes a focus chair configured to operably couple to the carrier assembly via a pulley assembly and a second line, such that the focus chair is configured to travel in a direction perpendicular to the length of the track.

A variety of additional aspects will be set forth in the description that follows. The aspects can relate to individual features and to combination of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description.

FIG. 1 illustrates an example focus track system.

FIG. 2A illustrates an example mounting system and a cross-sectional view of an example track.

FIGS. 2B and 2C illustrate an example splice assembly.

FIG. 2D illustrates an enlarged portion of the example focus track system of FIG. 1.

FIGS. 2E and 2F illustrate an example turndown assembly.

FIGS. 2G and 2H illustrate an example turnaround assembly.

FIG. 2I illustrates an example carrier assembly.

FIG. 2J illustrates an example pinch plate side of the example carrier assembly of FIG. 2I.

FIG. 2K illustrates an example guide block side of the example carrier assembly of FIG. 2I.

FIG. 3 illustrates an example focus chair.

FIGS. 4A and 4B illustrate another example focus chair.

FIGS. 5A-5D illustrate an example loaded arbor of the example focus track system of FIG. 1.

FIGS. 6A and 6B illustrate example parts of an unassembled focus track system stored in a package.

FIG. 7 illustrates an example focus track system.

FIGS. 8A-8E illustrate various views of an example turndown assembly.

FIGS. 9A-9E illustrate various views of an example turnaround assembly.

FIGS. 10A-10E illustrate various views of an example floor sheave.

FIG. 11A-11D illustrate various views of an example lifting trolley.

FIG. 11E illustrates an interior view of the example lifting trolley.

FIG. 11F illustrates a top view of the example lifting trolley.

FIG. 11G illustrates an enlarged view of section A in FIG. 11F.

FIGS. 11H-11I illustrate isometric views of the example lifting trolley.

FIG. 12A-12D illustrate various views of an example trolley.

FIG. 12E illustrates an interior view of the example trolley.

FIG. 12F illustrates a top view of the example trolley.

FIGS. 12G-12H illustrate isometric views of the example trolley.

FIG. 13A illustrates an enlarged view of an example end stop positioned on an end of the example focus track.

FIG. 13B illustrates an isometric view of the example end stop.

FIGS. 14A and 14B illustrate example parts of an unassembled focus track system.

### DETAILED DESCRIPTION

The following discussion omits or only briefly describes conventional features of focus track systems that are apparent to those skilled in the art. It is noted that various embodiments are described in detail with reference to the drawings, in which like reference numerals represent like parts and assemblies throughout the several views. Reference to various embodiments does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations.

Unless otherwise specifically defined herein, all terms are to be given their broadest reasonable interpretation including meanings implied from the specification as well as meanings understood by those skilled in the art and/or as defined in dictionaries, treatises, etc. It is noted that, as used in the specification and the appended claims, the singular forms “a,” “an” and “the” include plural referents unless otherwise specified, and that the terms “includes” and/or “including,” when used in this specification, specify the presence of stated features, elements, and/or components, but do not preclude the presence or addition of one or more other features, steps, operations, elements, components, and/or groups thereof.

Relative terms such as “horizontal,” “vertical,” “up,” “down,” “top,” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively or operably connected” is such an attachment, coupling or connection that allows the pertinent structures to operate as intended by virtue of that relationship.

Reference throughout the specification to “one embodiment”, “an embodiment” or “some embodiments” means that a particular feature, structure, or characteristic described in connection with an embodiment is included in at least one embodiment of the subject matter disclosed. Thus, the appearance of the phrases “in one embodiment”, “in an embodiment” or “in some embodiments” in various places throughout the specification is not necessarily referring to the same embodiment. Further, the particular features, structures or characteristics of “one embodiment”, “an embodiment” or “some embodiments” may be combined in any suitable manner with each other to form additional embodiments of such combinations. It is intended that embodiments of the disclosed subject matter cover modifications and variations thereof. Terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Moreover, throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6, and any whole and partial increments there between. This applies regardless of the breadth of the range. As used herein, the term “about” in reference to a measurable value, such as an amount, a temporal duration, and the like, is meant to encompass the measurable value and/or variations of plus or minus 20%, plus or minus 10%, plus or minus 5%, plus or minus 1%, and plus or minus 0.1% of the specified value, as such variations are appropriate.

The term “line” may refer to any rope, wire, chain, and the like that may be used to rig, support, and/or manipulate one or more components.

Conventional focus track systems are fixed at a certain height from the floor. To access the track, an operator climbs a ladder and transfers to the focus track chair while being elevated above the ground. This process is generally dangerous and requires specialized training to perform these complicated maneuvers at height. The operator may move horizontally at the fixed height of the track by pulling themselves along the track. However, by using the conventional focus track system, the operator may only work at the fixed height of the track and cannot move the focus chair up or down to work at another height. Rather, the operator would have to use multiple tracks at different trim positions or reset the height the focus track system. Further, in the case of an emergency the operator may be unable to move themselves into a safe position for rescue.

The exemplary focus track system, as described herein, provides easier installation than conventional focus track systems by utilizing one or more of improved hardware that streamlines track and other component connections, a carrier assembly with integrated ascent and fall protection systems that allows installation to be performed at ground level, and an adjustable arbor safety line that allows for flexible trim height. The exemplary focus track system, as described herein, is more accessible, as an operator gets into the focus chair at ground level, thereby eliminating the need to transfer into the focus chair while being at a fixed height in a conventional focus track system. Further, the exemplary focus track system allows an operator of the focus chair and/or a ground operator to control the ascent and descent of the focus chair. In one or more cases, the exemplary focus track system allows an operator to more easily traverse across the focus track at any trim height and not just at track level. Additionally, the exemplary focus track system provides for easier rescue in case of emergencies. For example, a ground operator can traverse the focus chair operator to any accessible location along the track. In another example, a self-retracting device of the focus track system may be switched into auto descent mode from a personnel lift or with a reaching pole. Embodiments of the focus track system are described below with reference to the Figures.

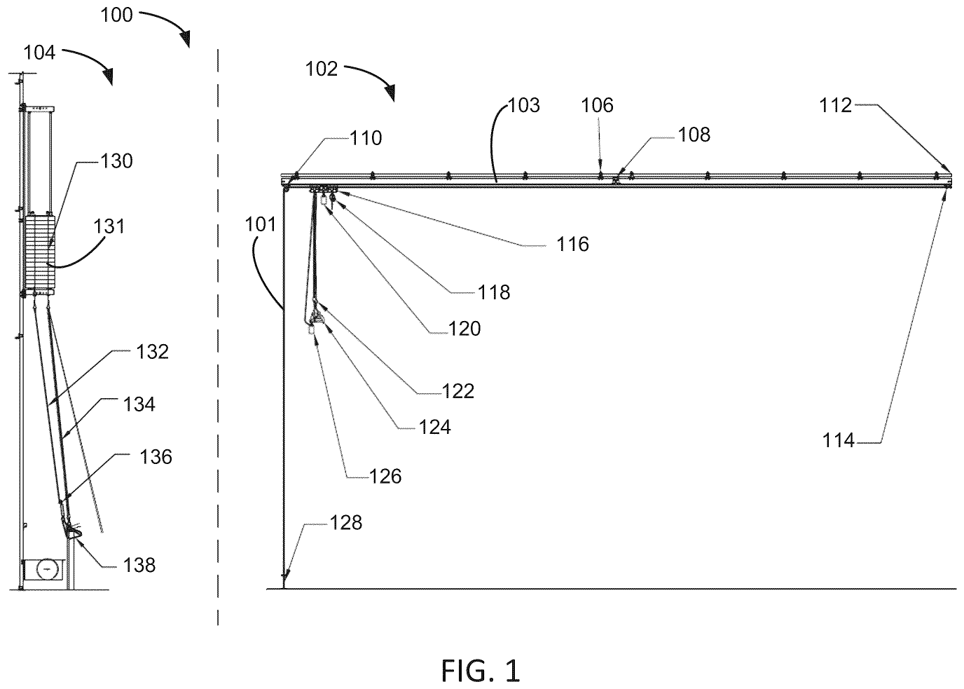

FIG. 1 illustrates an example focus track system 100 having a track system 102 operably coupled with a counterweight system 104. The track system 102 includes one or more tracks 103 coupled to one another via a track splice assembly 108. In one or more cases, the tracks 103 are coupled to a pipe batten 112 via one or more batten couplers 106. The track system 102 may include a pulley assembly 128 coupled to a ground surface, such as a theater floor. The track system 102 may include a turndown pulley assembly 110 and a turnaround pulley assembly 114 positioned at opposing ends of the track 103. A carrier assembly 116 may translate along the length of the track 103. For example, a portion of the carrier assembly 116 may be fastened to a traveler line 101 that is operably coupled to at least the pulley assembly 128, turndown pulley assembly 110, and the turnaround pulley assembly 114. As the traveler line 101 moves about the pulley assembly 128, turndown pulley assembly 110, and the turnaround pulley assembly 114, the carrier assembly 116 moves about the track 103 in a direction corresponding to the direction of movement of the traveler line 101.

The carrier assembly 116 is operably coupled with, for example, but not limited to, a focus chair 124, a fall protection system, and one or more bags/buckets, such as buckets 120 and 126. In some cases, objects may be operably coupled to the carrier assembly 116, such that the carrier assembly 116 may move the object along the track 103. The carrier assembly 116 may be configured to move objects that weigh up to about 350 pounds. The fall protection system may include a self-retracting lifeline (SRL) 118. For example, a lanyard of the SRL 118 may be coupled to the carrier assembly 116 and a person who is positioned in the focus chair 124. In the possible event that the person falls out of the focus chair 124 while suspended above the ground, the SRL 118 may activate by locking the lanyard in position and preventing the person from falling any farther. The buckets 120 and 126 may be used to store, for example, but not limited to, excess traveler line 101, tools, theater equipment, and the like. For example, the bucket 120 coupled to the carrier assembly 116 may be used to store excess traveler line 101, and bucket 126 coupled to the focus chair 124 may be used to store tools, excess line of a personal mechanical advantage system 122, and the like.

The counterweight system 104 may be a fly system used to raise and lower the height of a batten, such as pipe batten 112, and a track, such as track 103, from the ground. The counterweight system 104 may include an arbor 131 having a plurality of weights. In one or more cases, a combined weight of the arbor 131 and its weights may have the same or similar weight as that of the pipe batten 112 and the one or more tracks 103, thus allowing the pipe batten 112 and the one or more tracks 103 to remain at a fixed elevation when not being raised or lowered. As more weight is added to the pipe batten 112 and the one or more tracks 103, more weight may be added to the arbor 131 to rebalance the load, and vice versa, as more weight is removed from the pipe batten 112 and the one or more tracks 103, more weight may be removed from the arbor 131.

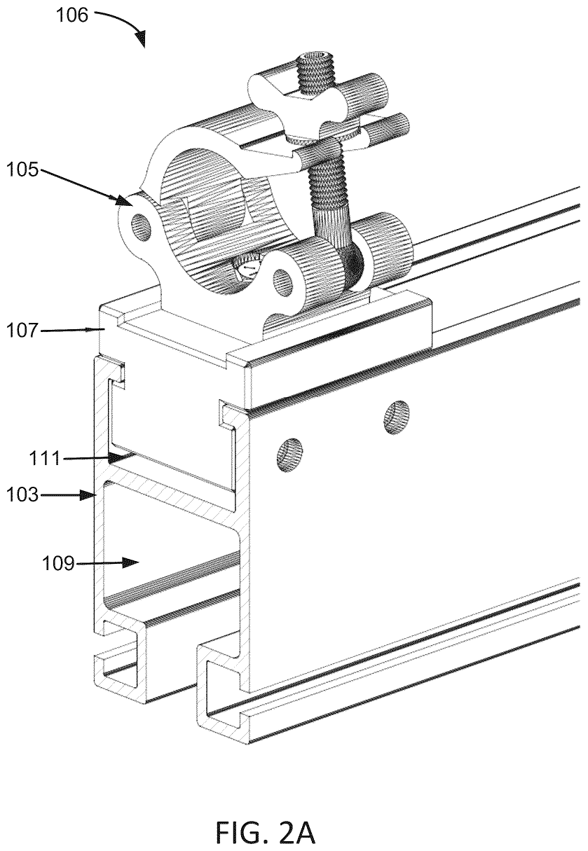

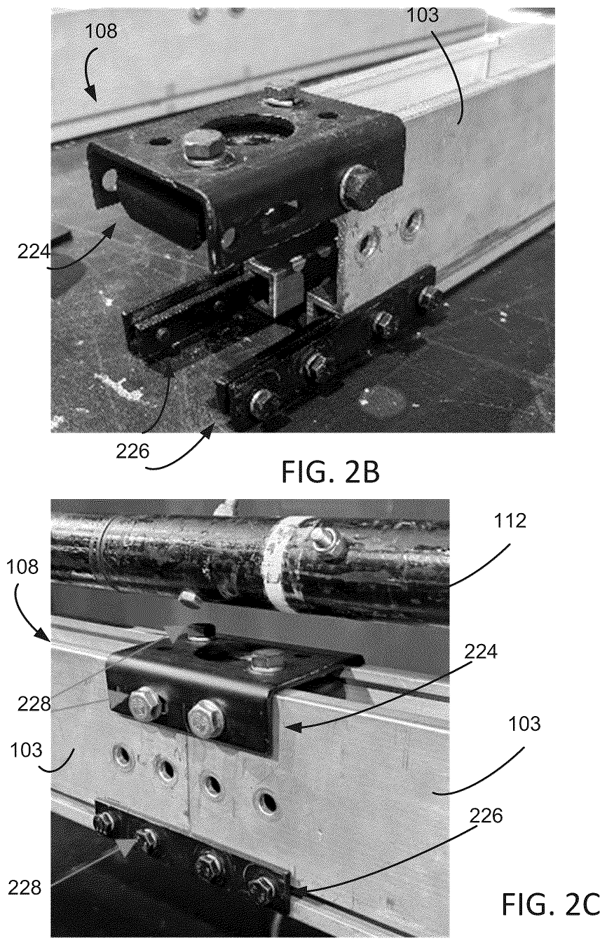

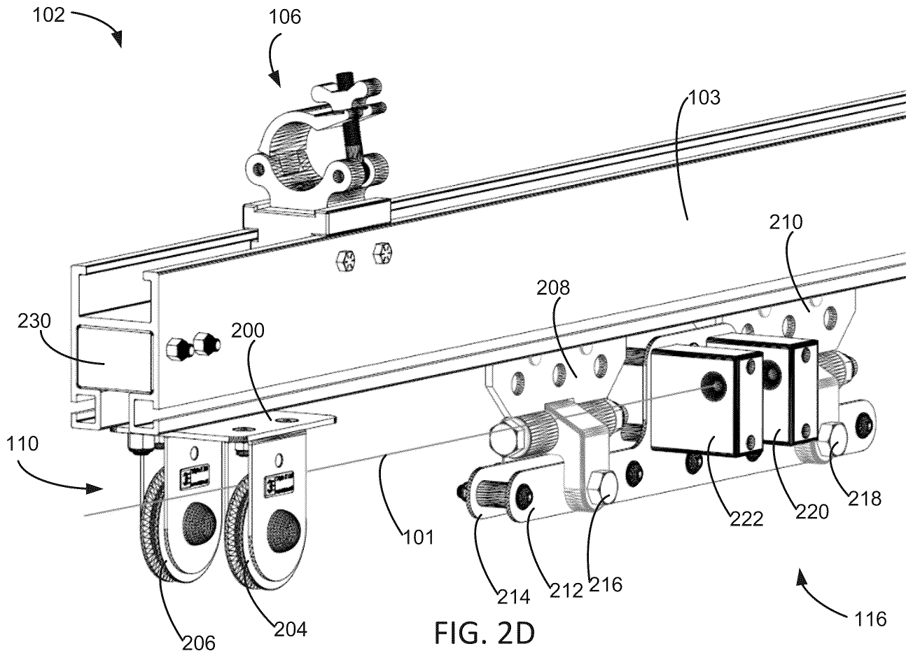

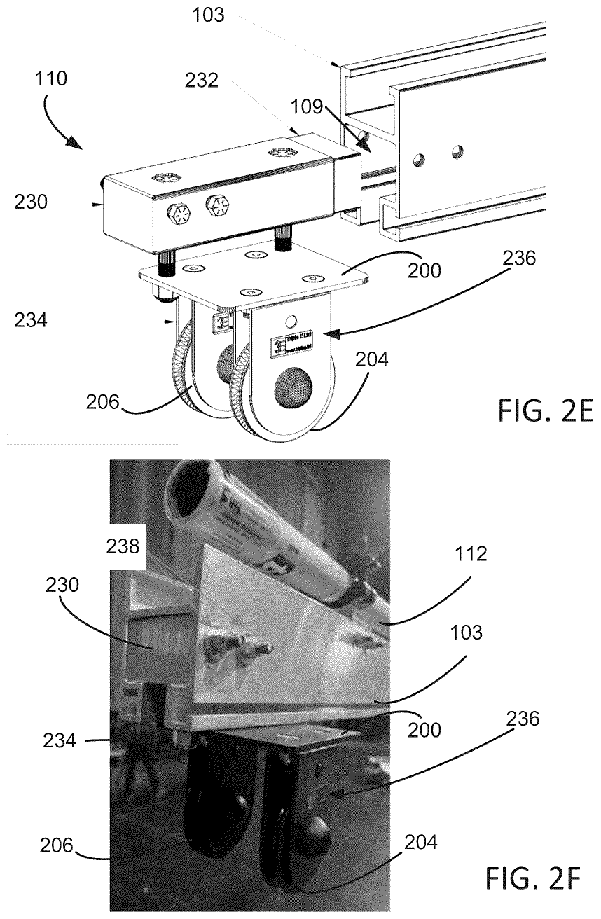

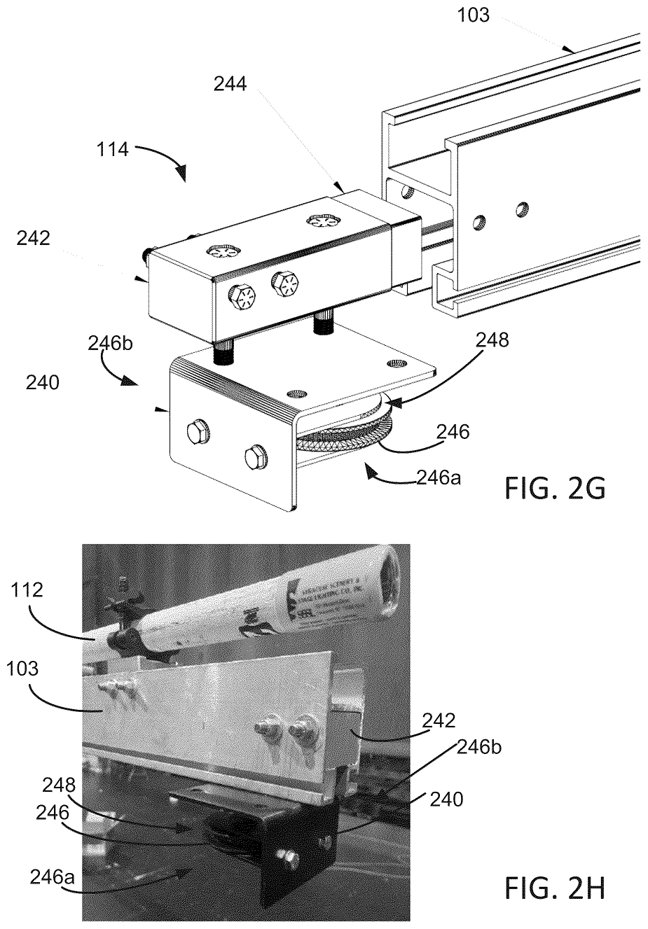

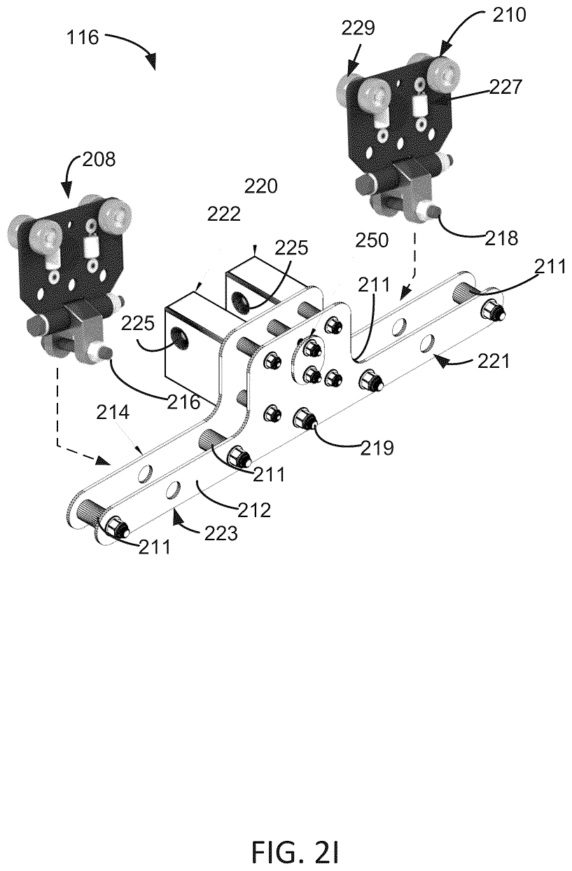

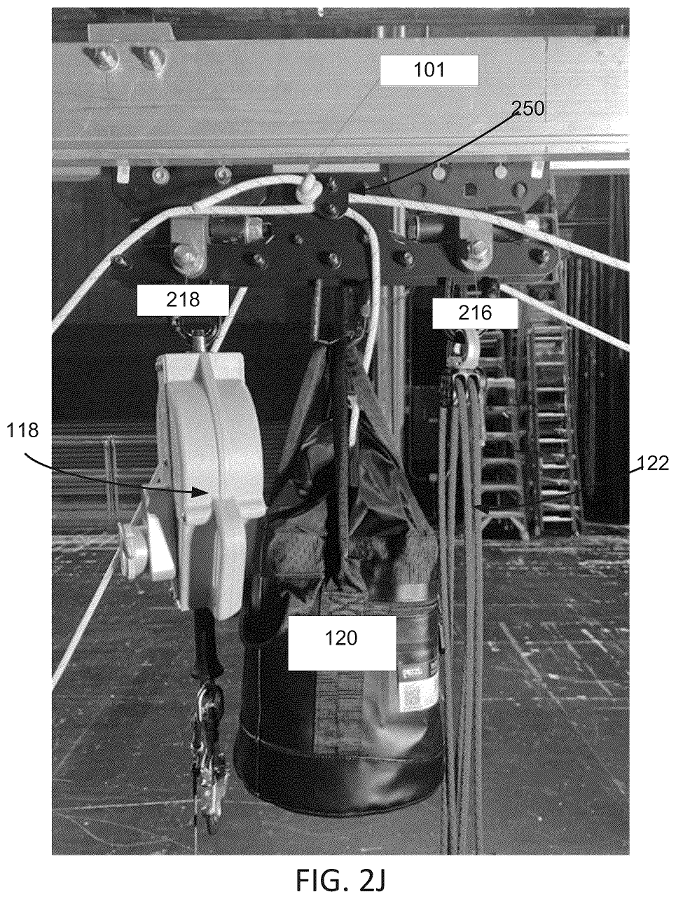

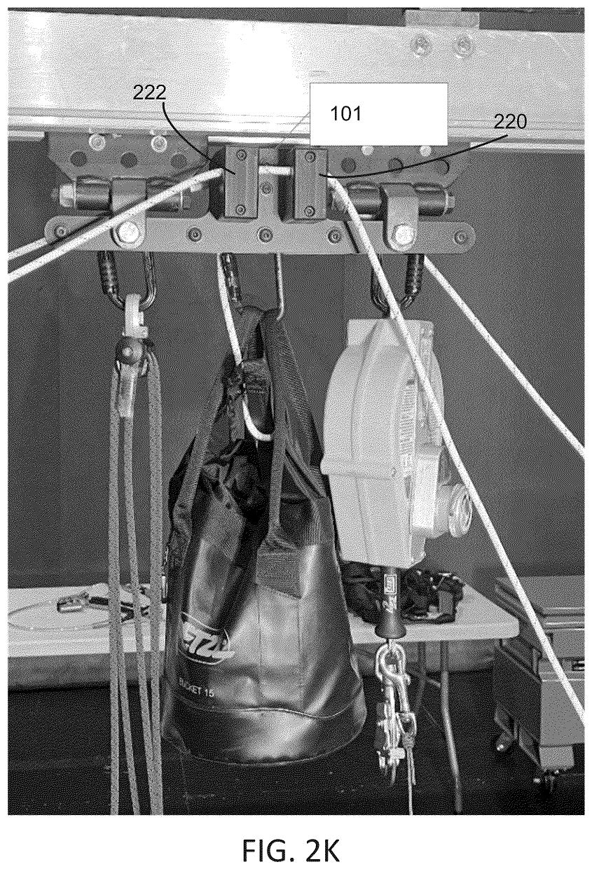

FIG. 2A illustrates an example mounting system, such as a batten coupler 106, and a cross-sectional view of the track 103. The track 103 may be a rigid member having at least one channel sized to allow the carrier assembly 116 to translate along the length of the track 103. For example, the track 103 may include a channel 109 disposed therein. In such cases, the channel 109 may be sized to allow a drive system, such as trolleys 208 and 210, of the carrier assembly 116 to ride along a portion of the channel 109 within the track 103. For example, the wheels of the trolleys 208 and 210 as illustrated in FIG. 2I may ride along a portion of the channel 109 within the track 103. In another example, the channel 109 of the track 103 may be disposed on the outside of the track 103. In such cases, the drive system of the carrier assembly 116 is configured to ride along the channel 109 disposed on the exterior of the track 103.

The track 103 includes a plurality of batten couplers 106 disposed along the length of the track 103. The pipe batten 112 may be coupled to the track 103 via the plurality of batten couplers 106. In some cases, the plurality of batten couplers 106 are removably coupled to the track 106. For example, a batten coupler 106 may include a mounting block 107 fastened to an adjustable coupler 105. The mounting block 107 may be positioned within a channel 111 of the track 103 and fastened to the track 103 via one or more fasteners, such as a bolt (e.g., a bolt having 0.5625 inches (in.) head and a length of about 3.5 in. to 4 in.). The portion of the mounting block 107 that resides within the channel 111 may be about 2.5 in. wide. The portion of the mounting block 107 that overlaps the top of the track 103 may be about 3 in. wide. The adjustable coupler 105 may be fastened to the mounting block 107 via one or more fasteners, such as bolt. The inner diameter of the adjustable coupler 105 may be increased or decreased in size to accommodate various sized pipe battens. To fasten the pipe batten 112 to the adjustable coupler 105, the pipe batten 112 may be positioned through the opening that defines the inner diameter of the adjustable coupler 105. The adjustable coupler 105 may then be tightened around the pipe batten 112, securing the pipe batten 112 to the track 103. In other cases, the mounting blocks 107 are integrated with the track 103 forming a unibody construction. As such, the plurality of batten couplers 106 are fixed to the track 103, such that adjustable coupler 105 is directly attached to the track 103.

The length of the focus track 102 may be increased by coupling together a plurality of tracks 103. For example, a plurality of tracks 103 may be coupled together, such that the overall length is about 50 feet. A track splice assembly 108 may be used to fasten one track 103 to an adjacent track 103, as illustrated in FIGS. 2B and 2C. The track splice assembly 108 may include splicing couplers 224 and 226. The splicing couplers 224 and 226 may be fastened to an end of one track 103, as shown in FIG. 2B. For example, the splicing couplers 224 and 226 may be bolted to the track 103. In some cases, the splicing couplers 224 and 226 may be mounted to the top and bottom of the track 103. In some cases, a splicing coupler, such as splicing coupler 224, may be mounted over the top of the track 103. In some cases, a splicing coupler, such as splicing couplers 226 may be inserted into a respective channel of the track 103. Having fastened the track splice assembly 108 to an end of one track, an end of another track 103 may be fastened to the track splice assembly 108 in a same or similar manner. For example, the splicing couplers 224 and 226 may be bolted to the other track 103 via bolts 228 (e.g., bolts having 17-millimeter (mm) head, and bolts having a 13 mm head), as illustrated in FIG. 2C.

FIG. 2D illustrates an enlarged portion of the focus track system 102. FIGS. 2E and 2F illustrate the turndown assembly 110. FIGS. 2G and 2H illustrate the turnaround assembly 114.

The turndown assembly 110 includes a mounting block 230 coupled to pulleys 204 and 206. For example, the pulleys 204 and 206 may be mounted to a plate 200 via brackets 236 and 234, respectively, as illustrated in FIGS. 2E and 2F. The pulleys 204 and 206 may be arranged in a vertical direction with the pulley 204 being offset from the track 103. The pulley 204 may be aligned with at least one guide block, such as guide blocks 220 and 222, of the carrier assembly 116. In some cases, the pulley 206 may be centered along a width of the track 103. In other cases, the pulley 206 may be positioned off-centered underneath the track 103. A portion of the traveler line 101 may pass from the floor pulley assembly 128 through the pulley 206 towards the pulley 246 of the turnaround assembly 114. Another portion of the traveler line 101 may pass from the pulley 246 of the turnaround assembly 114 through at least one guide block of the carrier assembly 116, and through the pulley 204 to the floor pulley assembly 128.

The plate 200 is coupled with the mounting block 230. For example, fasteners (e.g., such as two Grade 8½ in.×3½ in. bolts) may be inserted through the mounting block 230 and loosely fitted to the plate 200. The mounting block 230 may be sized to fit within the channel 109 of the track 103. The mounting block 230 may be positioned within the channel 109 of the track 103 and fastened to the track 103 via, for example, fasteners 238 (e.g., such as two Grade 8⅜ in.×3¾ in. bolts) or another fixation method. The fasteners coupling the plate 200 and mounting block 230 may be tightened to one another, securing the turndown assembly 110 to the track 103. In some cases, the mounting block 230 is formed from a rigid material, such as but not limited to, aluminum, and like material. The mounting block 230 may be used to stop the carrier assembly 116 from exiting an end of the track 103. In some cases, a proximal end of the mounting block 230 includes a rubber bumper 232. The rubber bumper 232 may dampen an impact caused when a portion of the carrier assembly 116 translates along the channel 109 and contacts the turndown assembly 110. The portion of the rubber bumper 232 may be disposed outside of the mounting block 230 by about ½ in. to 2 in.

The turnaround assembly 114 includes a mounting block 242 coupled to the pulley 246. For example, the pulley 246 may be mounted to an angled plate 240 via bracket 248, such that the pulley 246 is arranged in a horizontal direction, as illustrated in FIGS. 2G and 2H. A side 246a of the pulley 246 that is offset from the track 103 may be aligned with one or both of the pulley 204 of the turndown assembly 110 and at least one guide block, such as guide blocks 220 and 222, of the carrier assembly 116. The side 246b of the pulley 246 that is positioned underneath the track 103 may be aligned with the pulley 206 of the turndown assembly 110. The mounting block 242 and rubber bumper 244 of the turnaround assembly 114 include the same or similar features as the mounting block 230 includes a rubber bumper 232 of the turndown assembly 110, and as such, a description of such features is not repeated.

FIG. 21 illustrates the carrier assembly 116. FIG. 2J illustrates an example pinch plate side of the carrier assembly 116. FIG. 2K illustrates an example guide block side of the carrier assembly 116. The carrier assembly 116 includes spreader plates 212 and 214 that are spaced apart from one another via spacers 211 and coupled to one another via fasteners, a portion of which pass through the respective spacers 211. The spacers 211 may be about 1 in to 2 in in length. Trolleys 208 and 210 are coupled to the spreader plates 212 and 214 via inserting the rods 216 and 218 of the yokes of trolleys 208 and 210 through the through-holes 223 and 221 provided in spreader plates 212 and 214. By coupling the trolleys 208 and 210 to the spreader plates 212 and 214 via rods 216 and 218, the carrier assembly 116 is configured to translate along the channel 109 of the track 103 via the wheels (e.g., wheels 227 and 229) of the trolley. In some cases, the rods 216 and 218 may be, for example, a bolt, or other like fastener that may be used to couple the trolleys 208 and 210 to the spreader plates 212 and 214. Rods 216 and 218, in addition to rod 219, may be used to attach accessories to the carrier assembly 116, such as the focus chair 124, bucket 120, and SRL 118. In one or more cases, rods, such as rods 216 and 218, are load rated to hold the weight of a person or other large objects, and other rods, such as rod 219, may be load rated to hold the weight of accessories, such as bucket 120. In other cases, all of the rods may be load rated to hold the weight of a person or other large objects. In yet other cases, all of the rods may be load rated to hold the weight of accessories. An accessory may be coupled to a rod by, for example, a carabiner.

Spreader plate 212 includes a pinch plate 250. An end of the traveler line 101 may be positioned in between the spreader plate 212 and the pinch plate 250. The pinch plate 250 may be tightened onto the spreader plate 212, such that the end of the traveler line 101 is fixed in between the spreader plate 212 and pinch plate 250, as illustrated in FIG. 2J. That is, the pinch plate 250 may be used to fix the traveler line 101 to the carrier assembly 116. Spreader plate 214 includes one or more guide blocks, such as guide blocks 220 and 222. Guide blocks 220 and 222 each include through-holes 225 sized to allow the traveler line 101 to pass therethrough, as illustrated in FIG. 2K. In some cases, the guide blocks 220 and 222 are formed from a rigid material, such as ultra-high molecular weight polyethylene (UHMW), other plastics, metals, alloys, and like materials. The guide blocks 220 and 222 may each have, for example, a dimension of about 3 in×3 in×1.5 in.

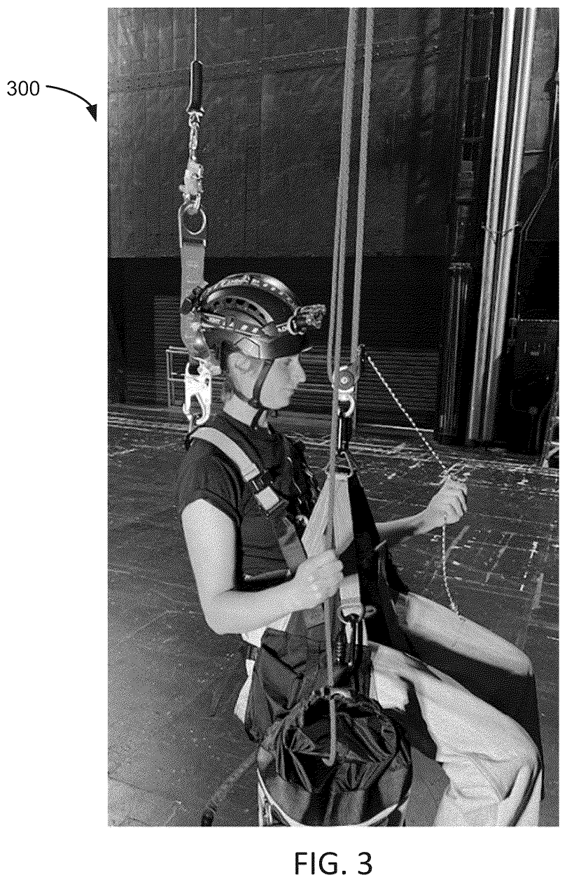

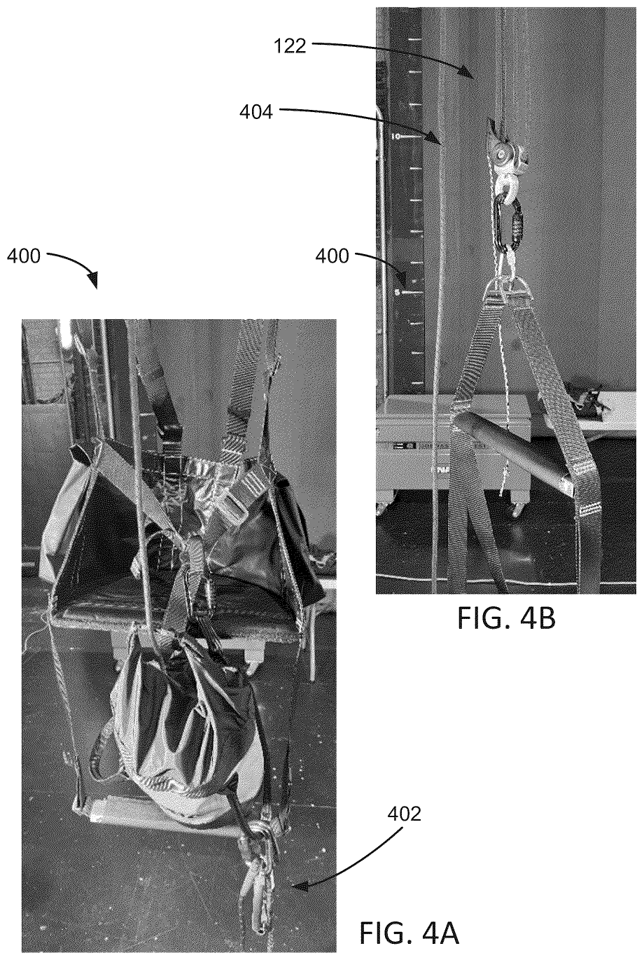

Returning to FIG. 1, the focus track system 102 is configured such that a person may gain access at any point along the track 103. For example, the system 102 allows a person in the focus chair 124 to ascend or descend in a vertical direction, and traverse across the length of the track 103. FIGS. 3, 4A, and 4B illustrate focus chair 300 and focus chair 400, respectively, that may be coupled with a carrier assembly 116 in a same or similar manner as focus chair 124. The focus system 102 provides case of access. That is, a person may get into the focus chair 124 at ground level, eliminating the need to transfer to another chair while elevated above the ground. Any of the focus chairs 124, 300, and 400 may be operably coupled to the carrier assembly 116 via a personal mechanical advantage system 122, such as a Harken Wingman, of FIG. 1. The person may don a full body harness before sitting in the focus chair 124. The focus chair 300 may be, for example, a Harken Bosun's chair, in which the person sits in the focus chair 300 before being attached to the carrier assembly 116, via the system 122. The focus chair 400 may be, for example, a DBI-SALA Workman's chair, in which the focus chair 400 is coupled to the carrier assembly 116, via the system 122.

In one or more cases, two or more tracks 103 may be coupled to one another via the track splice assembly 108, and the tracks 103 may be coupled to the pipe batten 112 via the batten couplers 106, as described herein. The carrier assembly 116, and in particular, the trolleys 208 and 210, may be operably coupled to the channel 109 of the track 103. The turndown assembly 110 and turnaround assembly 114 may be coupled to the respective ends of the track 103.

Having assembled the focus track system 102, the traveler line 101 may be reeved through the system 102. The length of the traveler line 101 may be determined by adding the trim height of the track 103 with the overall length of the track 103 (e.g., about 40 ft or about 50 ft) and doubling the sum of the trim height and overall length. For the cases in which the length of the traveler line 101 is incorrect, the length of the traveler line 101 may be adjusted via the pinch plate 250 on the carrier assembly 116, or the track 103 may be flown higher (e.g., up to about 50 ft). One end of the traveler line 101 may be reeved through the pinch plate 250 and fastened to the carrier assembly 116 via the pinch plate 250. In some cases, a knot, such as a stopper knot, may be tied on one side of the pinch plate 250, as illustrated in FIG. 2J, to prevent the traveler line 101 from detaching from the carrier assembly 116. The opposite end of the traveler line 101 may be reeved through the pulley 206 of the turndown assembly 110 and around the pulley of the floor pulley assembly 128. From the floor pulley assembly 128, the traveler line 101 may be reeved through the pulley 204 of the turndown assembly 110 and through the through-hole 225 of the at least one guide block, such as guide blocks 220 and 222, of the carrier assembly 116. The traveler line 101 passes through the at least one guide block to the pulley 246 of the turnaround assembly 114, as illustrated in FIG. 2K. The traveler line 101 may traverse around the pulley 246 via side 246a of the pulley 246 and exiting side 246b of the pulley 246 towards the carrier assembly 116. The traveler line 101 may pass through the pinch plate 250 of the carrier assembly 116, as illustrated in FIG. 2J. The pinch plate 250 may be tightened onto the carrier assembly 116 and around both portions of the traveler line 101, thereby fixing the carrier assembly 116 to the traveler line 101.

Excess line of the traveler line 101 may be placed in the bucket 120. The bucket 120 may be, for example, but not limited to, a Petzl Bucket 15 L rope bag. The bucket 120 may be attached to a rod of the carrier assembly 116. For example, bucket 120 may be attached to the rod 219 of the carrier assembly 116. In other examples, the bucket 120 may be attached to either rod 216 or rod 218. The bucket 120 may be attached to the rod of the carrier assembly 116 via a carabiner, such as, but not limited to a Petzl OXAN carabiner, as illustrated in FIG. 2J.

The SRL 118 may be attached to one of the rods of the carrier assembly 116. For example, the SRL 118 may be attached to either of rods 216 or 218 of the carrier assembly 116. The SRL 118 may be attached to one of the rods of the carrier assembly 116 via a carabiner, such as, but not limited to a Petzl OXAN carabiner, as illustrated in FIGS. 2J and 2K. The SRL 118 may have a line length of about 50 ft. In some cases, an accessory line may also be attached to the SRL 118.

The system 122 may be connected to one of the rods of the carrier assembly 116. For example, the system 122 may be attached to either of rods 216 or 218 of the carrier assembly 116. For instance, when assembled, the system 122 may be attached to rod 216 and the SRL 118 may be attached to the rod 218. The system 122 may be attached to one of the rods of the carrier assembly 116 via a carabiner, such as, but not limited to a Petzl OXAN carabiner, as illustrated in FIGS. 2J and 2K. In one or more cases, the sheave assembly with the sewn rope termination of the system 122 should be high, and the sheave assembly with the release paddle of the system 122 should be low. In one or more cases, the system 122 may be paid out with enough line such that the release paddle is accessible from the floor when the track 103 is positioned at the trim height.

In one or more cases, the line set may be snubbed, and weights may be added to the counterweight system 104 to balance the system 100. In some cases, the line set may be snubbed and the system 100 balanced using standard practice. In some cases, about 272 lbs may be added to the counterweight system 104 for a track system 102 having a length of 40 ft. For instance, the track 103 may weigh about 4.3 lbs/ft. That is, a track length of 20 ft may weigh about 86 lbs, a track length of 30 ft may weigh about 129 lbs, and a track length of 40 ft may weigh about 172 lbs. About 100 lbs may be estimated for the additional equipment of the system 102. The weight added to the counterweight system 104 may be tested and added or removed as needed to balance the system 100. The weight of the person positioned in the focus chair 124 and the person's tools may not be accounted for when balancing the system 100.

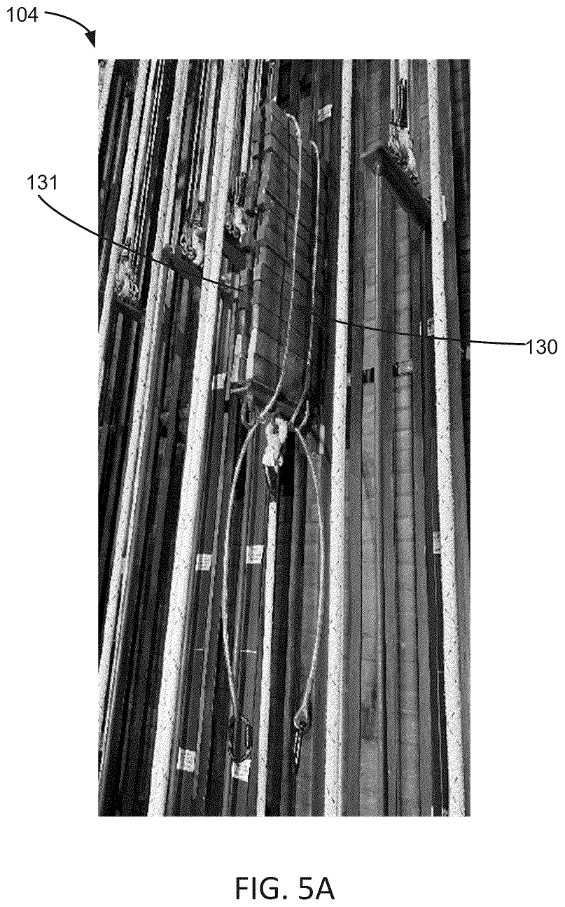

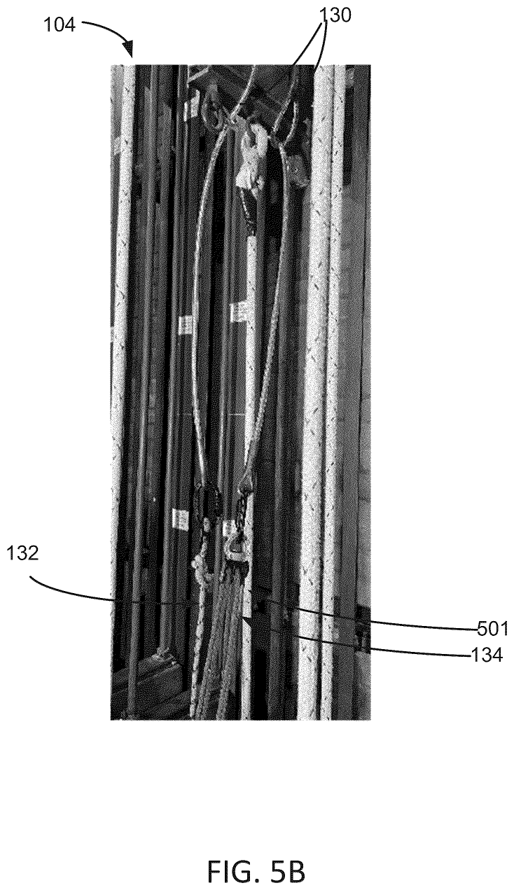

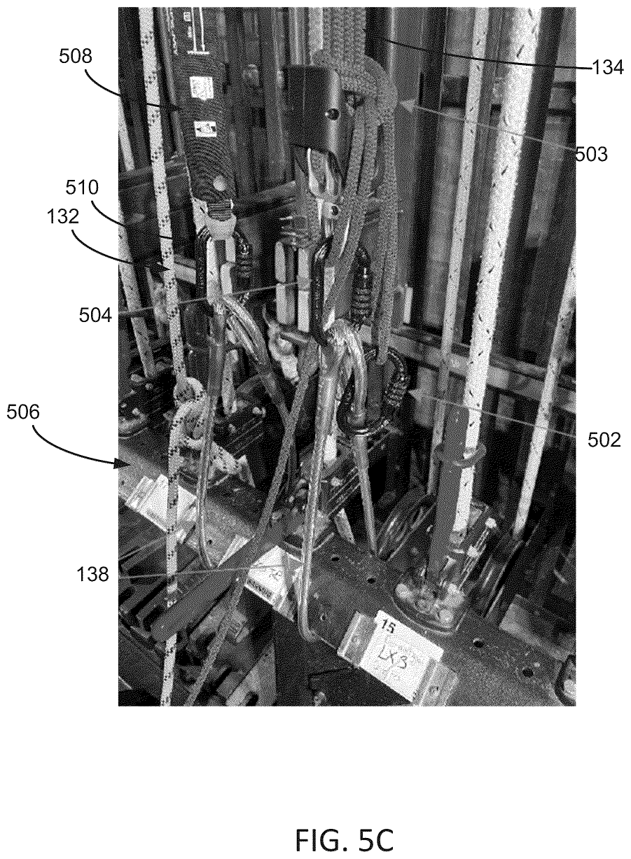

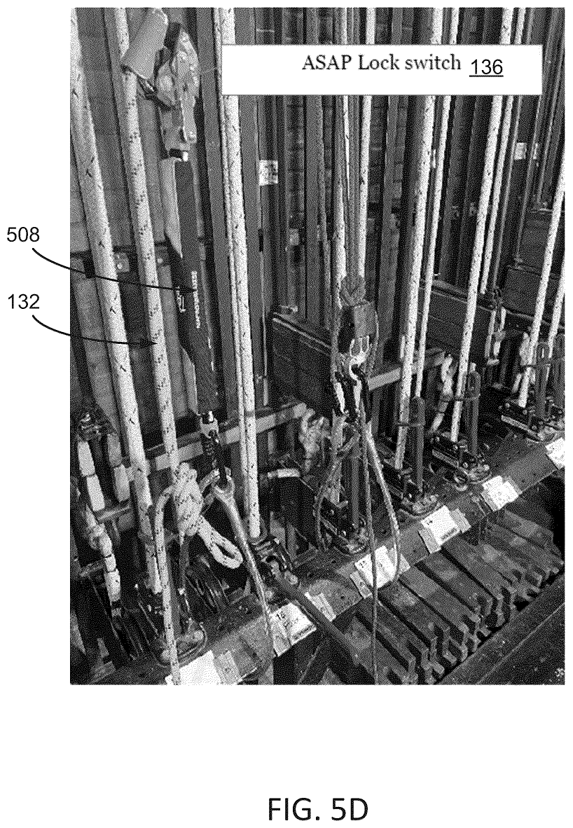

Having balanced the system 100, the arbor 131 of the counterweight system 104 may be secured, as illustrated in FIGS. 5A-5D. With the system 104 in weight, the batten 112 is flown out until the arbor 131 is accessible from the floor. Wire strops 130 are added to the arbor 131 and locking rail. The wire strops 130 may be, for example, Petzl Wire Strops. The wire strops 130 may be for example 300 cm Petzl Wire Strops. In one or more cases, the wire strops 130 may be choked around the counterweight and arbor 131, as illustrated in FIG. 5A. An end of a line 132 is attached to an end of one of the wire strops 130 via a carabiner, as illustrated in FIG. 5B. The line 132 may be, for example, but not limited to, a 7/16 in. or 11 mm static kern mantle rope, such as Petzl Ray. The end of the line 132 attached to the wire strop 130 may be the sewn termination end of the line 132. An end 501 of the Harken Wingman 134 may be attached to the end of the other wire strop 130 via a carabiner, as illustrated in FIG. 5B. The end 501 of the Harken Wingman 134 may be, for example, the sheave assembly with rope termination. The carabiners may be, for example, an OXAN carabiners.

In one or more cases, wire strops 138 may be coupled around the locking rail 506. That is, a user may basket the wire strops 138 around the locking rail 506 on either side of the rope lock, as illustrated in FIG. 5C. The wire strops 138 may be, for example, but not limited to, 100 cm wire strops. Another end of the Harken Wingman 134, such as the sheave assembly with release paddle, may be coupled to one of the wire strop 138, via, for example, a carabiner 502. In one or more cases, the end 503 of the Harken Wingman 134 may be tied off with, for example, a double half-hitch on a bight of the Harken Wingman 134. In one or more cases, a bight of the end 503 of the Harken Wingman 134 may pass through a carabiner 504 that is coupled with wire strop 138. A bight of another portion of the end 503 of the Harken Wingman 134 may pass through another carabiner 502 that is attached to an eye of the wire strop 138, as illustrated in FIG. 5C. A mobile fall arrester with locking function and energy absorber 508, such as the Petzl ASAP lock switch 136 with Petzl ASAP'Sorber Axess, may be attached to the other wire strop 138 via, for example, a carabiner 510, as illustrated in FIGS. 5C and 5D.

The arbor 131 may be secured to the locking rail 506 at a desired trim height. For example, one person may operate the counterweight system 104, and another person may pay out the Harken Wingman 134 to set the trim height. The line 132 may be reeved through the mobile fall arrester with locking function 508, as illustrated in FIG. 5D. The locking function (e.g., lock switch 136) may not be activated yet. A person may not be put on the system 102 until the lock switch 136 is configured in the locked position. The floor pulley assembly 128 may be coupled to the stage using fasteners (e.g., 1⅝ in GRK screws). In one or more cases, the tension of the traveler line 101 may be adjusted via the floor pulley assembly 128. For example, the floor pulley assembly 128 may include a tensioner (e.g., wingnuts on the pulley of the floor pulley assembly 128) that may be tightened or loosened. For the cases in which more tension is needed, the Harken Wingman 134 coupled to the arbor 131 may be collapsed. The Harken Wingman 134 may be tied off, as illustrated in FIG. 5C. The lock switch 136 may then be toggled in the locked position, as illustrated in FIG. 5D, and the system 102 is ready for use.

For the cases in which the system 102 utilizes a focus chair, such as focus chair 300, a person may wear a full body harness. The focus chair 300 may be wrapped around the waist of the person who is positioned under the system 122, as illustrated in FIG. 3. The focus chair 300 is attached to the system 122 with a carabiner. A waist strap is reeved through a central seat strap and buckle of the chair 300. The SRL 118 is attached with a lanyard connector 118b to a dorsal D-ring of the full body harness. In some cases, an accessory line 118a of the SRL 118 is removed. The accessory line 118a may be placed in a pocket of the chair 300. The bucket 126 is attached to the chair 300 with, for example, a carabiner. The bucket 126 may be attached to a D-ring on the chair 300 or an appropriate point on the body harness. The bucket 126 may be secured to the side of the person's dominant hand. The straps of the chair 300 and body harness may be adjusted for comfort.

For the cases in which the system 102 utilizes a focus chair, such as focus chair 400, a person may wear a full body harness. The focus chair 400 may be attached to the system 122 with a carabiner, as illustrated in FIGS. 4A and 4B. The person may sit in the chair 400. A waist strap is reeved through a loop in the central seat strap and buckle. The SRL 118 is attached with a lanyard connector 118b to a dorsal D-ring of the body harness. In some cases, an accessory line 118a of the SRL 118 is removed. The accessory line 118a may be placed in a pocket of the chair 400. The bucket 126 is attached to the chair 400 with, for example, a carabiner. The bucket 126 may be attached to a D-ring on the chair 400 or an appropriate point on the body harness. In some cases, the bucket 126 may be secured to the side of the person's dominant hand. In other cases, the bucket 126 may be secured between the person's legs. The straps of the chair 400 and body harness may be adjusted for comfort.

With a person secured to the focus chair 124 (e.g., focus chair 300 or focus chair 400), the SRL 118 attached, and equipment secured, the person may be hoisted into position on the track 103 via pulling or paying out the line of the system 122 (e.g., line 404 illustrated in FIG. 4B). In some cases, the person may be hoisted by a ground crew member. In other cases, the person may hoist themselves, via for example, a handle ascender 402, as illustrated in FIG. 4A. The person may put excess line of the system 122 in the bucket 126, which helps manage the excess line. A ground crew member may hold the traveler line 101 still or tie off the traveler line 101 while the person ascends towards the track 103 or descends from the track 103. Tying off or holding the traveler line 101 keeps the carrier assembly 116 motionless in the track 103. Once the person in the focus chair 124 is positioned at height, a ground crew member may pull the traveler line 101 to traverse the person in the focus chair 124 along the track 103 via the carrier assembly 116.

To lower the focus chair 124, the person in the focus chair 124 holds the haul line of the system 122 in one hand and releases the paddle of the system 122 slowly with the other hand. For the cases in which the person uses the focus chair 300, the release paddle may be positioned directly in front of the worker and is easy to access. For the cases in which the person uses the focus chair 400, the release paddle may be positioned above the person. A tagline may be added to provide the person with access to the release paddle. In one or more cases, the system 122 release paddle does not have a panic clutch. Thus, if the person pulls the release paddle too far without controlling the haul line, the person will descend fast enough to engage the SRL 118. The person may practice the lowering maneuver close to the ground before ascending higher towards the track 103.

Equipment of the system 100 was tested to be person-rated via a series of destructive tests. The first of the destructive tests included testing a trolley, such as trolleys 208 and 210, directly in line with a custom mounting block. Using a hydraulic tester, the trolley was pulled to failure. The test was performed three times. A new trolley, track segment, batten pipe, and mounting block assembly were used in each test. In all three tests, one of the trolley axles was the failure point. The axle of the first trolley failed at 10,080 lbf. The axle of the second trolley failed at 11,016 lbf. The axle of the third trolley failed at 11,016 lbf. These findings indicate the general strength of the hardware, which is far beyond the required 1,800 lbf, so as not to cause concern.

The second of the destructive tests centered a trolley on a 4 ft by 6½ in. span of track hanging from 1½ in schedule 40 pipe with a trim chain at center. This simulates the worst-case load condition on a theatre fly system batten. Using the same hydraulic tester as the first test, the assembly was pulled to failure. The assembly failed at 4,200 lbf. The pipe bent far enough to act as a lever arm against the coupler that attaches the pipe batten to the track, causing the coupler to shear at its hinge. Again, the results indicate that the assembly can easily withstand the required lbf.

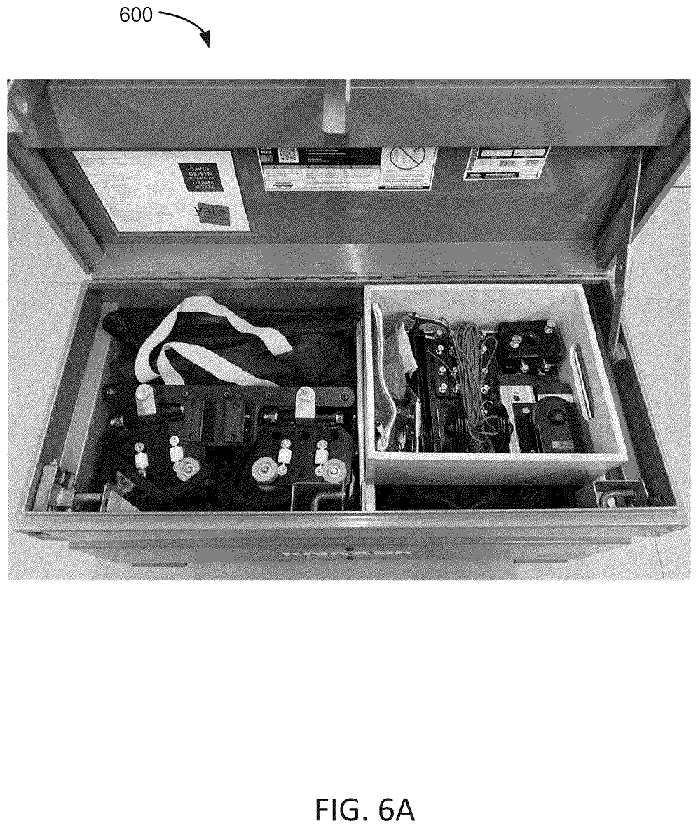

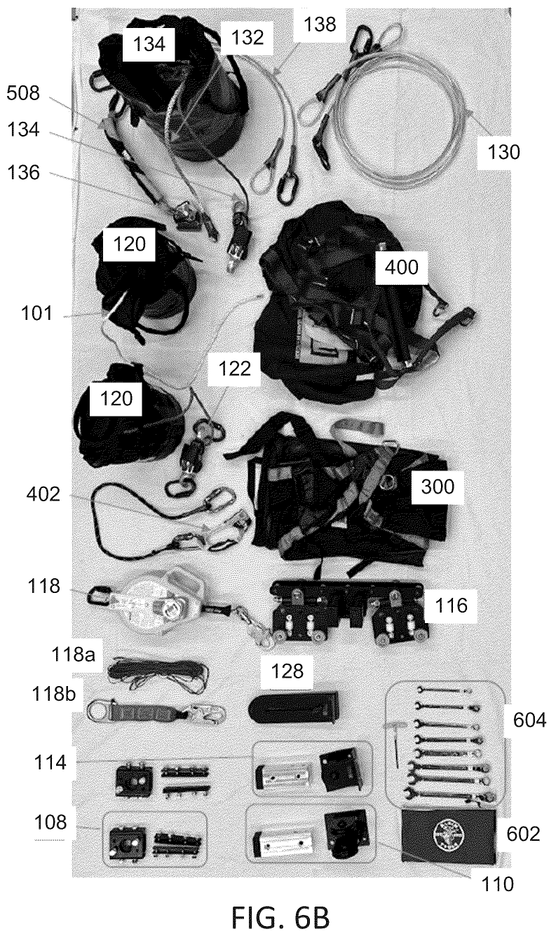

In one or more cases, the system 100 may be provided as a kit. For example, as illustrated in FIGS. 6A and 6B, parts of the system 100 may be provided unassembled in a package 600, such as, but not limited to, a Knaack Box. In some cases, the package 600 also include a tool bag 602 and tools 604 to assemble the system 100.

The focus track system 100 may be used to traverse a person along a span of the track 103 to reach otherwise inaccessible items, such as, but not limited to lighting instruments, stage scenery, and the like. The system 100 increases worker safety, decreases installation time, and facilitates prompt rescue in an emergency beyond what is currently available. The improved hardware streamlines track and other component connections. The carrier assembly 116 with integrated ascent and fall protection systems allows all installation to be performed at ground level. The adjustable arbor safety line allows for flexible trim height. Further, as a worker may enter the focus chair 124 at ground level, the worker no longer needs to transfer to another chair at height. The worker may control the ascent and descent from the focus chair 124. Additionally, a ground worker may control the ascent and descent of the focus chair 124. Moreover, as the traveler line 101 is ground-based, the worker may traverse the track 103 at any trim height. The ground worker may traverse the worker in the focus chair 124 to any accessible location via the traveler line 101. In case of emergency, the SRL 118 may be switched into auto descent mode from a personnel lift or with a reaching pole.

The system 100 provides two personal mechanical advantage systems, in which one system is used to ascend and descend the worker in the focus chair, and the other system is used to adjust the trim height of the track 103. The track 103 may be made from, for example, a high-strength aluminum alloy that utilizes low friction trolleys 208 and 210, which allow for smooth operation and a high load capacity. The system 100 provides an energy absorber on the arbor safety line to alleviate shock loading in an emergency situation. The hardware to assemble the system 100 is provided for case and efficiency of use. For example, the couplers 106 may be integrated into the track 103 allowing for quick connection of the track 103 to the batten 112. The carabiners used in the system 100 may be provided at critical connections. The carabiners may be twist-lock carabiners to allow the system 100 to be easily reconfigured for user comfort and utility (e.g., providing multiple chair options). Moreover, the safety lines with sewn terminations provide increased strength and eliminate the need to tie knots. As such, the system 100 includes primary and secondary fall protection systems, and components that streamline installation as well as maintain complete tie-off throughout operation of the system 100.

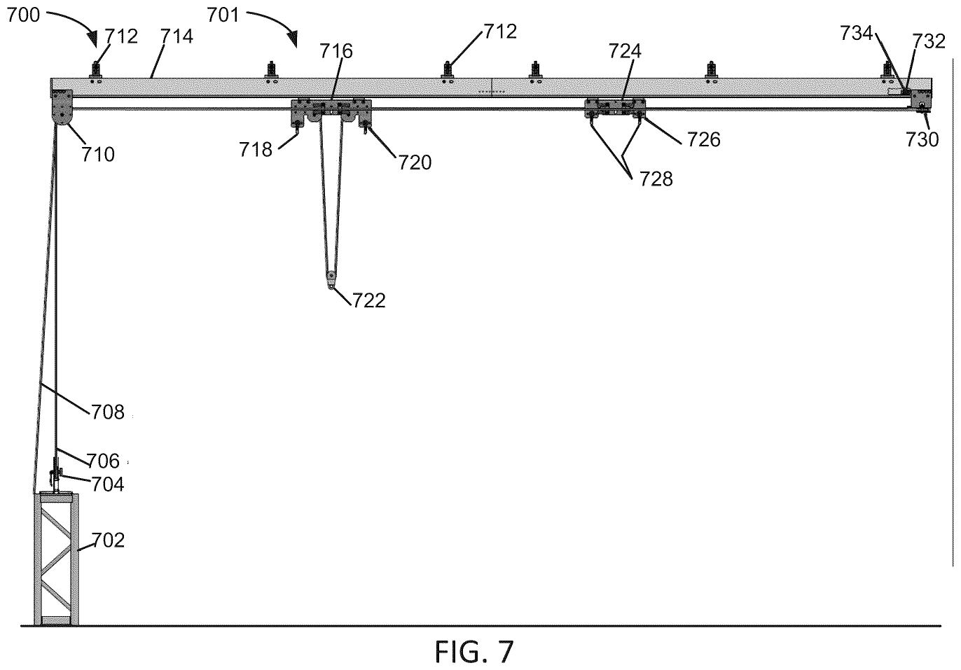

FIG. 7 illustrates an example focus track system 700 having a track system 701 operably coupled with a truss system 702. The track system 701 includes one or more tracks 714 coupled to one another via a track splice assembly, such as the track splice assembly 108. In one or more cases, the tracks 714 are coupled to a pipe batten, such as pipe batten 112, via one or more batten couplers 712. The truss system 702 may be coupled to a ground surface, such as a theater floor. The track system 701 may include a turndown assembly 710 and a turnaround assembly 730 positioned at opposing ends of the track 714. The track system 701 may include one or more trolleys, such as trolley 716 and trolley 724, that translate along the length of the track 714. For example, a portion of the trolley 716 may be fastened to a traveler line 706 that is operably coupled to a floor assembly 704 of the truss system 702, the turndown assembly 710, and the turnaround assembly 730. As the traveler line 706 moves about the floor assembly 704, turndown assembly 710, and the turnaround assembly 730, the trolley 716 moves about the track 714 in a direction corresponding to the direction of movement of the traveler line 706.

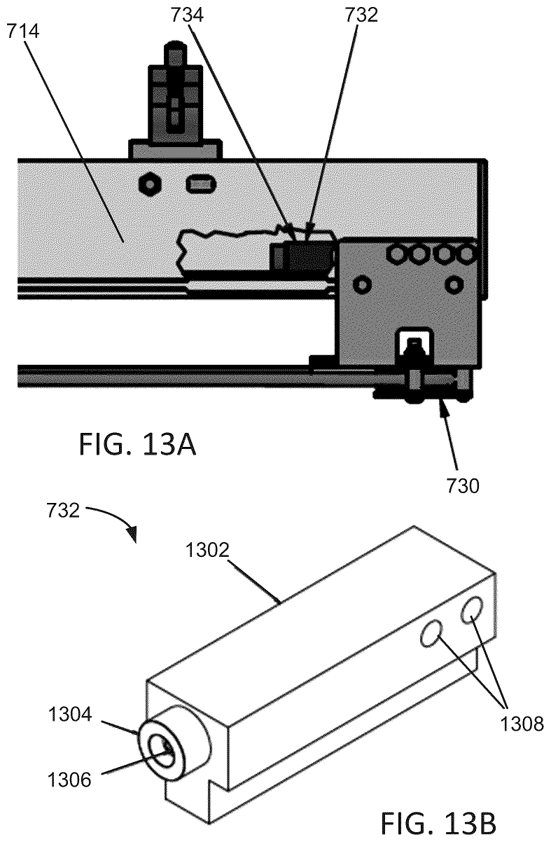

In one or more cases, the track 714 may include an end stop on one or both ends of the track 714. For example, the end stop 732 may be positioned on the end of the track 714 that includes the turnaround assembly 730. The end stop 732 may be secured to the track 714 in a position to prevent a trolley, such as trolley 716 or trolley 724, from contacting the respective end assembly, such as turnaround assembly 730 or turndown assembly 710. As illustrated in FIG. 13A, the end stop 732 may be secured to the track 714 by passing a fastener, such as a bolt, through through-holes in one or both of the track 714 and turnaround assembly 730 that align with the through-holes 1308 of the end stop 732, and securing the fastener on the opposite side of the track 714 and/or turnaround assembly 730. Further, as illustrated in FIG. 13B, the body 1302 of the end stop 732 may be shaped to fit within the track 714. In one or more cases, an end of the body 1302 that interfaces with a trolley may include a bumper 1304 to dampen the force generated when the trolley contacts the end stop 732. The bumper 1304 may be attached to the end of the body 1302 via a fastener 1306, such as a screw. In one or more cases, the length of the body 1302 may be longer or shorter based on the type of trolley used within the track 714. For example, an end stop with a longer body may be coupled to the turnaround assembly 730 when using the trolley 716 of the lifting system. In another example, another end stop having a shorter body may be coupled to the turnaround assembly 730 when using the trolley 724 of the basic system. It is noted that although the end stops are described as being located on one or both ends of the track 714, it should be understood that one or more end stops may be positioned along the track 714 to restrict the distance traveled by a trolley along the track 714. For instance, for the cases in which the track 714 includes two trolleys, an end stop may be placed in the middle of the track 714 to prevent one of the trolleys from travelling along the remaining half of the track 714.

Returning to FIG. 7, the trolley 716 and trolley 724 includes the same or similar features as the carrier assembly 116. The trolley 716 may be distinguishable from the carrier assembly 116 and trolley 724 in that trolley 716 may be a lifting trolley, in which a height of a worker or object suspended from the trolley 716 is adjusted from the ground. For example, a worker or object may be suspended from the trolley 716 via the pulley 722. The height of the pulley 722 may be raised or lowered by adjusting the length of the lifting line 708. In contrast, the trolley 724 may be similar to that of the carrier assembly 116 in which a worker that is suspended from the trolley 724 may control the height that the worker is suspended from the trolley 724. The trolleys 716 and 724 may each be coupled to one or more accessories. For example, trolleys 716 and 724 may be coupled to one or more of a focus chair 124, a fall protection system, and one or more bags/buckets, such as buckets 120 and 126. For instance, the focus chair 124 may be coupled to the pulley 722 of the trolley 716. Accessories may be attached to the trolley via anchors, such as anchors 718, 720, 728, and 726.

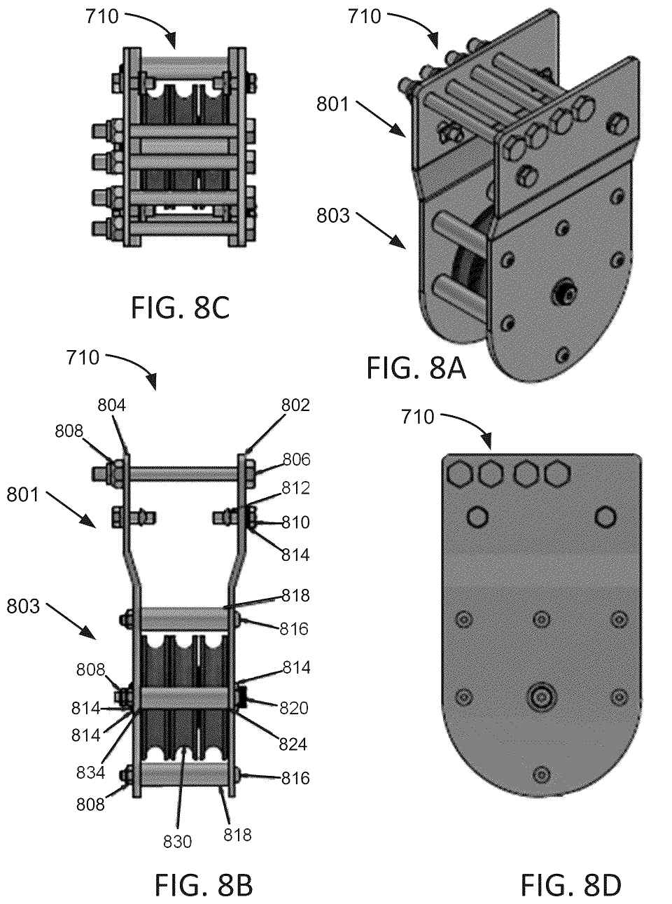

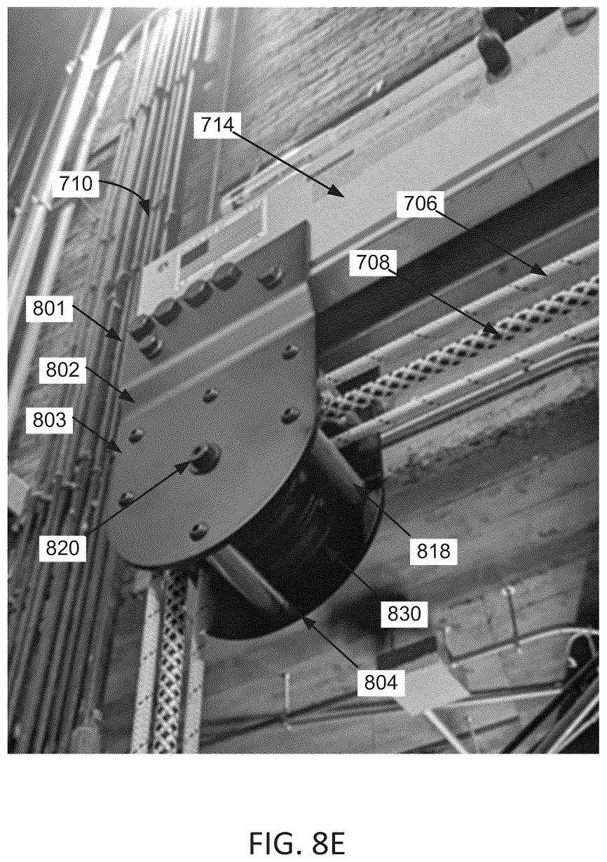

FIGS. 8A-8E illustrate various views of the turndown assembly 710. FIGS. 8A and 8E illustrate isometric views of the turndown assembly 710. FIGS. 8B and 8D are side views of the turndown assembly 710. FIG. 8C illustrates a top view of the turndown assembly 710. The turndown assembly 710 may include a plurality of pulleys 830 positioned between plates 802 and 804. The pulleys 830 may be arranged in a vertical direction with respect to the track 714 such that lines, such as the traveler line 706 and the lifting line 708, extend upwards towards the track 714 and then extend parallel to the length of the track 714. Each pulley 830 may be configured to receive a respective line. For instance, the traveler line 706 and lifting line 708 connected to the trolley 716 may each traverse their own respective pulley, and another traveler line connected to the trolley 724 may traverse its own respective pulley.

The top portion 801 of plates 802 and 804 may be positioned and fastened to the sides of the track 714, such that the bottom portion 803 of the plates 802 and 804 hangs below the track 714. In some cases, the plates 802 and 804 are substantially planar in shape. In other cases, the top portion of plates 802 and 804 may be flared outwards, such that the space between the top portion 801 of the plates 802 and 804 corresponds to the width of the track 714 and the space between the bottom portion 803 of the plates 802 and 804 corresponds to the width of the plurality of pulleys 830. The top portion 801 of the plates 802 and 804 may be coupled to the track 714 via a plurality of fasteners. For example, fasteners 806 may extend through both plates 802 and 804 and the track 714 and tightened via nuts 808. Additionally or alternatively, fasteners 810 may extend through washers 814 and each respective plate, in which the fasteners 810 couple the respective plate via a nut 812, such as a t-slotted drop in nut.

The bottom portion 803 of the plates 802 and 804 may be coupled to one another via fasteners 816 that pass through the plates 802 and 804 and a spacer 818 disposed between the plates 802 and 804. The fasteners 816 may be tightened onto the plates 802 and 804 via a nut 808. In one or more cases, a rod 820 may pass through the plates 802 and 804 and each of the pulleys 830 such that the pulleys 830 are axially aligned with one another. The rod 820 may be, for example, a shoulder screw. In some cases, the pulleys 830 may be spaced apart from one another and/or the plates 802 and 804 via one or more shims 834. A shim 834 may be, for example, a carbon steel ring shim.

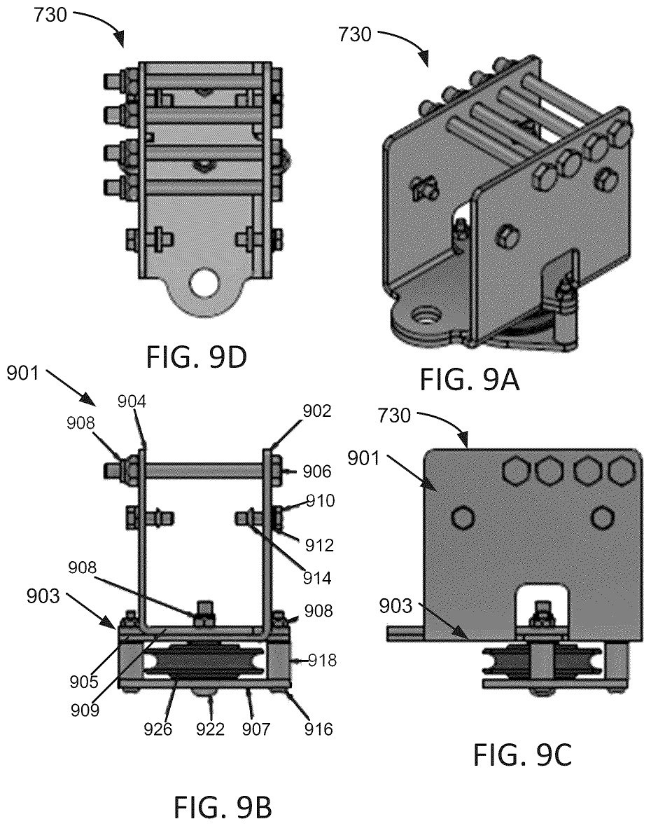

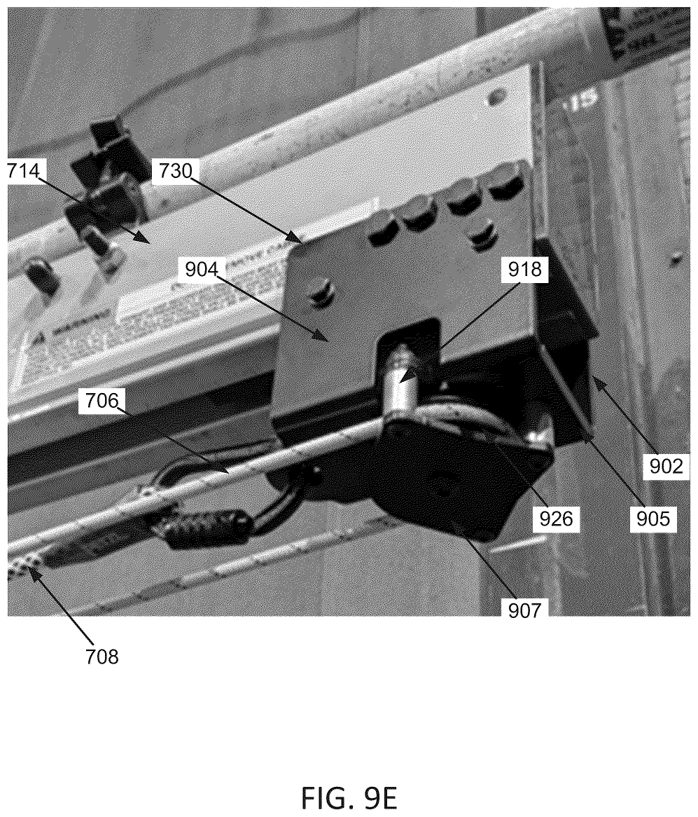

FIGS. 9A-9E illustrate various views of the turnaround assembly 730. FIGS. 9A and 9E illustrate isometric views of the turnaround assembly 730. FIGS. 9B and 9C illustrate side views of the turnaround assembly 730. FIG. 9D illustrates a top view of the turnaround assembly 730. The turnaround assembly 730 includes a pulley 926 arranged in a horizontal direction with respect to the track 714, such that a line, such as the traveler line 706 may extend along the length of the track 714. For instance, the traveler line 706 may extend towards the turnaround assembly 730 and pass around the pulley 926 of the turnaround assembly 730 to then extend away from the turnaround assembly 730.

The top portion 901 of the turnaround assembly 730 may be formed in a shape to fit around the track 714. For example, the top portion 901 of the turnaround assembly 730 may be formed in a U-like shape, such that side walls 902 and 904 are positioned on respective vertical sides of the track 714 and the bottom wall 909 is positioned to interface with the bottom of the track 714. The side walls 902 and 904 of the top portion 901 may be coupled to the track 714 via a plurality of fasteners. For example, fasteners 906 may extend through both side walls 902 and 904 and the track 714 and tightened via nuts 908. Additionally or alternatively, fasteners 910 may extend through washers 912 and each respective plate, in which the fasteners 910 couple the respective side wall via a nut 914, such as a t-slotted drop in nut.

In one or more cases, the bottom portion 903 of the turnaround assembly 730 may be formed by plates 905 and 907 coupled to one another via fasteners 916 that pass through the plates 905 and 907 and a spacer 918 disposed between the plates 905 and 907. The fasteners 916 may be tightened onto the plates 905 and 907 via a nut 908. In one or more cases, a rod 922 may pass through the plates 905 and 907, pulley 926, and the top portion 901, such that the pulley 926 is rotatably coupled to the bottom portion 903. The rod 922 may be, for example, a shoulder screw. In some cases, the pulley 926 may be spaced apart from plates 905 and 907 via one or more shims. A shim may be, for example, a carbon steel ring shim. It is noted that although the turnaround assembly 730 is described as including two plates 905 and 907, it should be understood that may include only plate 907, in which the plate 907 and pulley 926 are coupled to the bottom side 909 of the top portion 901.

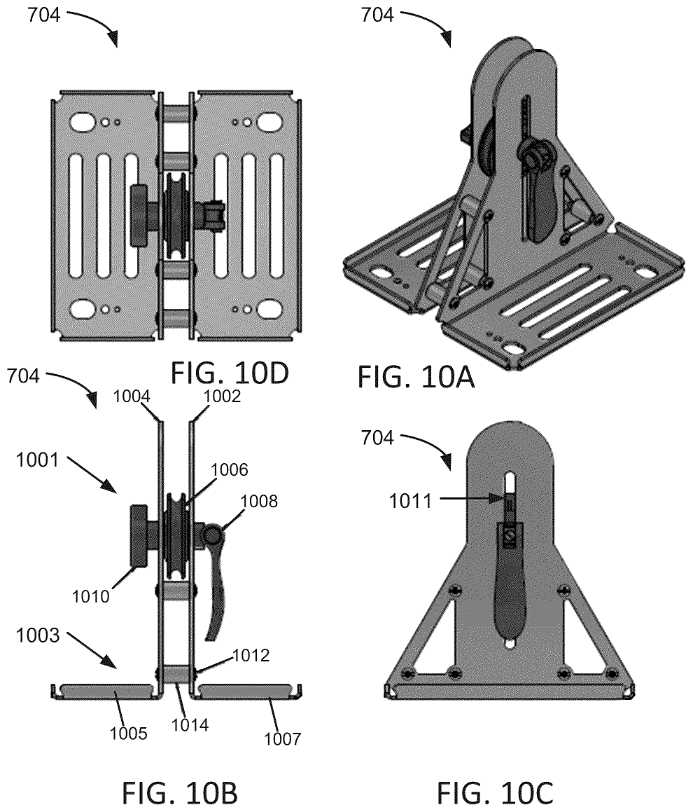

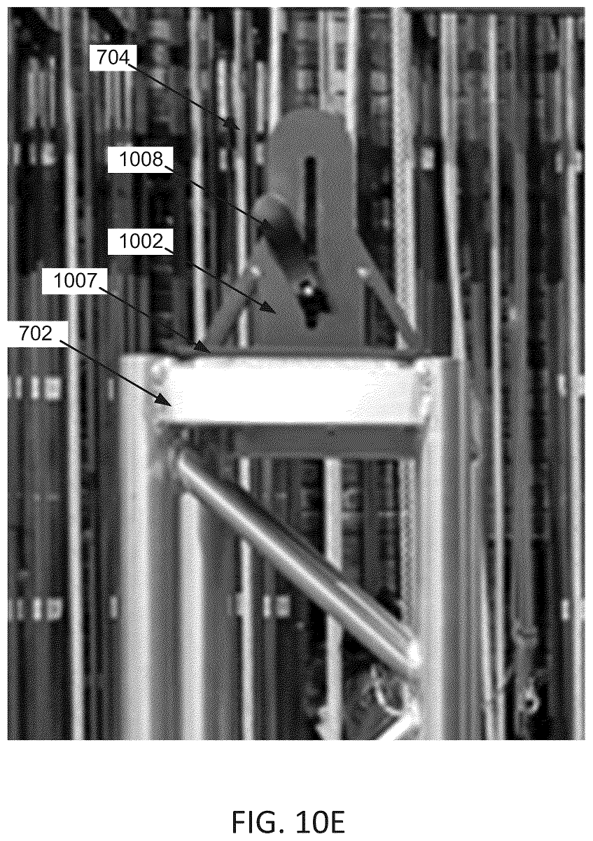

FIGS. 10A-10E illustrate various views of the floor assembly 704. FIGS. 10A and 10E illustrate isometric views of the floor assembly 704. FIGS. 10B and 10C are side views of the floor assembly 704. FIG. 10D is a top view of the floor assembly 704. The floor assembly 704 includes a vertical portion 1001 and a support portion 1003. The floor assembly 704 may be coupled to the truss system 702 via the support portion 1003. For instance, the support portion 1003 may include plates 1005 and 1007, which may be fastened to the truss system 702.

The vertical portion 1001 of the floor assembly 704 may include plates 1002 and 1004. The plates 1004 and 1005 may be one structure having a unibody structure. The plates 1002 and 1007 may be one structure having a unibody structure. The plates 1002 and 1004 may be spaced apart from another such that the pulley 1006 is disposed therebetween. The plates 1002 and 1004 may be coupled to one another via fasteners 1012 that pass through the plates 1002 and 1004 and a spacer 1014 disposed between the plates 1002 and 1004. The fasteners 1012 may be tightened onto the plates 1002 and 1004 via a nut. The pulley 1006 may be coupled to the plates 1002 and 1004 via a cam handle 1006 having a rod that passes through the pulley 1006 and is coupled to a knob 1010. In one or more cases, the pulley 1006 is adjustable along the plates 1002 and 1004. For example, the plates 1002 and 1004 include a track 1011. The knob 1010 and/or handle 1008 may be loosened to allow the pulley 1006 to be positioned in the track 1011. Once positioned in the track 1011, the knob 1010 and/or handle 1008 may be tightened to fix the position of the pulley 1006 with respect to the track 1011.

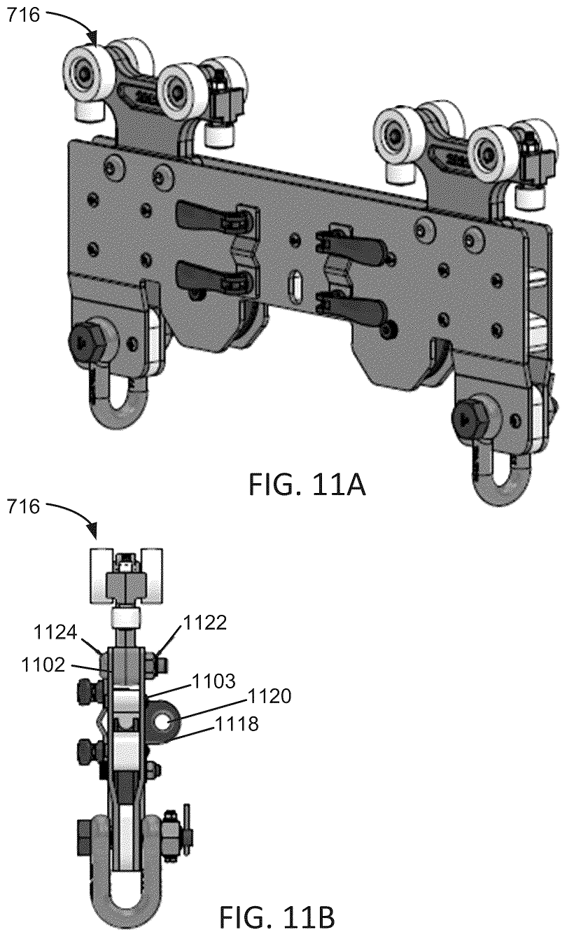

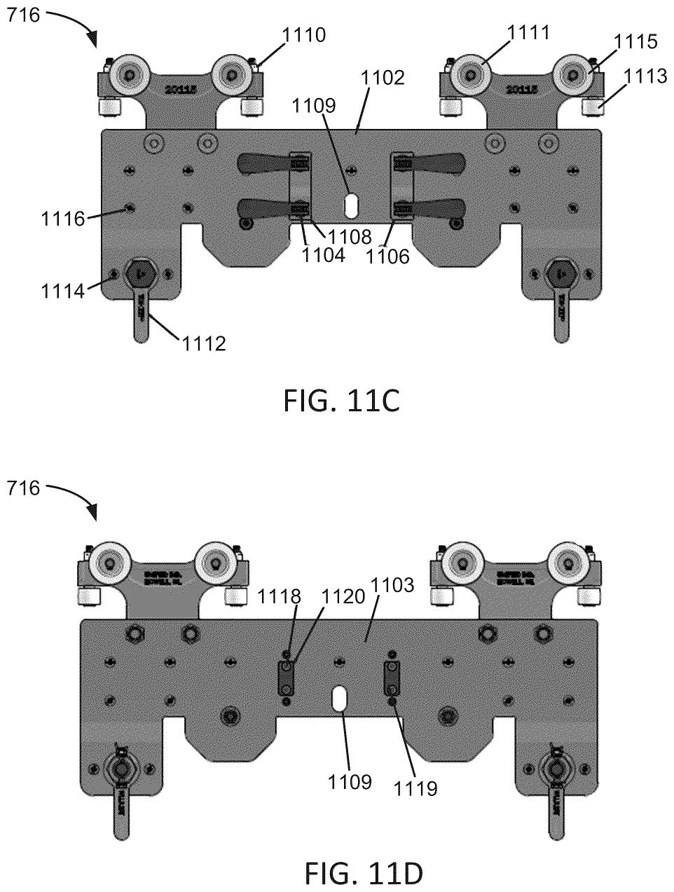

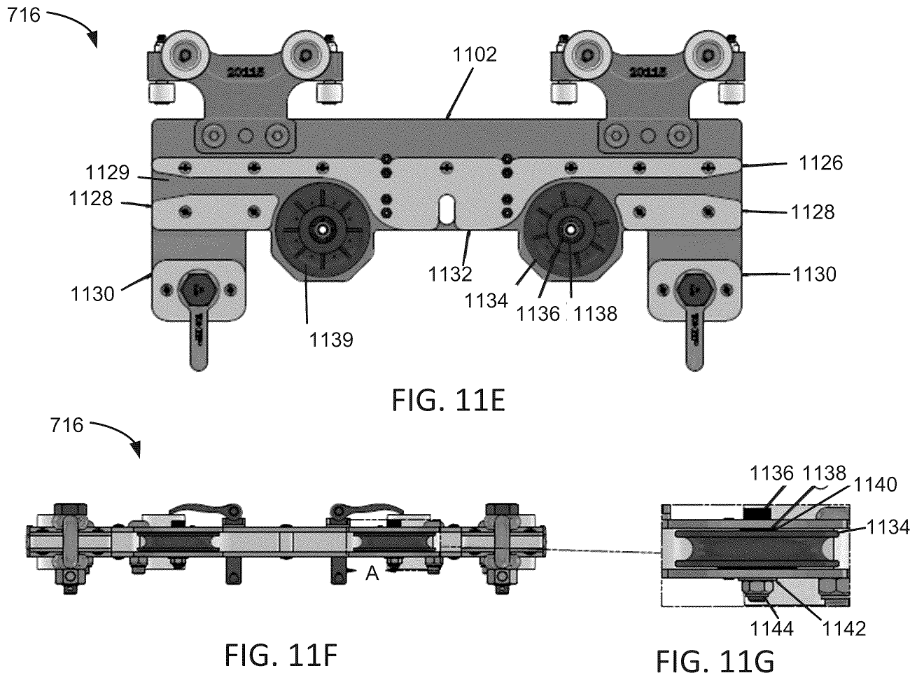

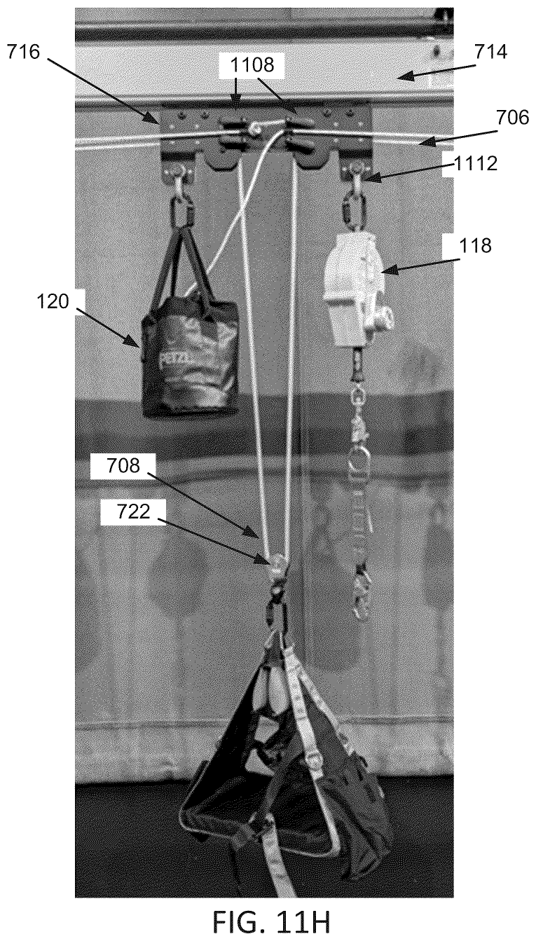

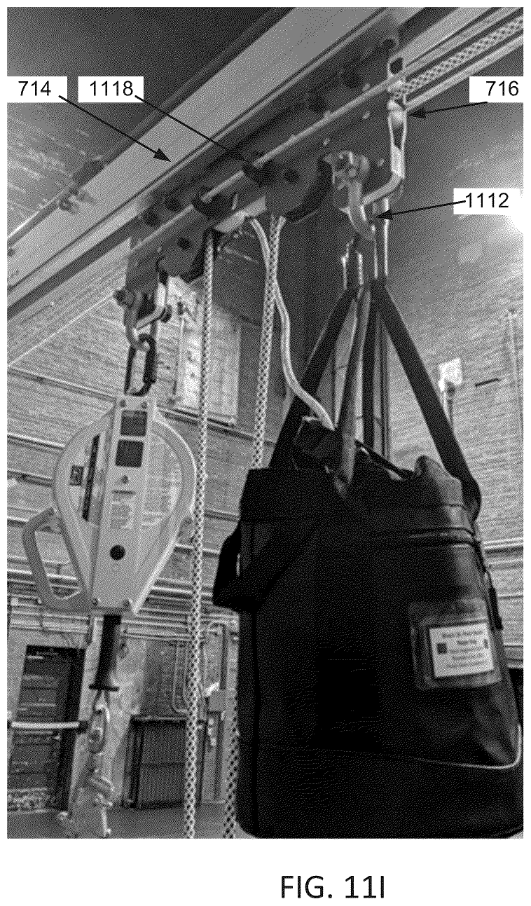

FIG. 11A-11I illustrate various views of the trolley 716. FIGS. 11A, 11H, and 11I illustrate isometric views of the trolley 716. FIGS. 11B-11D illustrates side views of the trolley 716. FIG. 11E illustrates an interior view of the trolley 716. FIG. 11F illustrates a top view of the trolley 716. FIG. 11G illustrates an enlarged view of section A in FIG. 11F.

The trolley 716 includes plates 1102 and 1103 that are spaced apart from one another via spacers, such as spacers 1126, 1128, and 1130. The plates 1102 and 1103 may be coupled to one another via fasteners (e.g., fasteners 1114 and 1116), a portion of which pass through the respective spacers. The trolley 716 includes trolley assemblies 1110 and 1111 coupled to the top of the plates 1102 and 1103, via fasteners 1124 tightened via nuts 1122. The trolley assemblies 1110 and 1111 each include one or more sets of wheels positioned to traverse an interior of the track 714. For example, wheels 1115 may roll along a bottom surface of the interior of the track 714, and wheels 1113 may roll along the side surfaces of the interior of the track 714.

The trolley 716 may include one or more anchor points, such as anchors 1112 and 1109, rated to carry various loads. In one or more cases, the anchor points are load rated to hold the weight of a person, large objects, and other accessories, such as bucket 120. In other cases, all of the anchor points may be load rated to hold the weight of a person or other large objects. In yet other cases, all of the anchor points may be load rated to hold the weight of accessories. An object may be coupled to an anchor point by, for example, a carabiner.

One of plates 1102 and 1103 may include a pinch assembly. The pinch assembly may include one or more pinch plates such as pinch plates 1104 and 1106 and cam handles 1108 to tighten the pinch plates 1104 and 1106 onto the respective one of plate 1102 and 1103. An end of the traveler line 706 may be positioned in between the plate, such as plate 1102, and the pinch plates 1104 and 1106. The pinch plates 1104 and 1106 may be tightened onto the plate 1102, such that the end of the traveler line 706 is fixed in between the plate 1102 and pinch plates 1104 and 1106. That is, the pinch plates 1104 and 1106 may be used to fix the traveler line 706 to the trolley 716.

One of plates 1102 and 1103 may include a guide assembly, including one or more guide blocks, such as guide blocks 1118 and 1119. Guide blocks 1118 and 1119 each include through-holes 1120 sized to allow the traveler line 706 to pass therethrough. In some cases, the guide blocks 1118 and 1119 are formed from a rigid material, such as ultra-high molecular weight polyethylene (UHMW), other plastics, metals, alloys, and like materials.

In one or more cases, the trolley 716 includes one or more pulleys, such as pulley 1134 and 1139, positioned in between plates 1102 and 1103. For example, pulley 1134 may be positioned in between plates 1102 and 1103 and rotatably coupled to the plates 1102 and 1103 via a shoulder screw 1136 that passes through the plates 1102 and 1103, a clevis adapter 1138, a shim 1140, and a washer 1142, and is fastened to a nut 1144. In one or more cases, the spacers 1126 and 1128 form a channel 1129 sized to receive the lifting line 708 therein. The lifting line 708 may pass through the channel 1129 and around pulley 1139 towards the pulley 722. From pulley 722, the lifting line 708 passes around the pulley 1134 and through the remaining portion of the channel 1129. The spacers 1126 and 1128 formed from a rigid material, such as ultra-high molecular weight polyethylene (UHMW), other plastics, metals, alloys, and like materials.

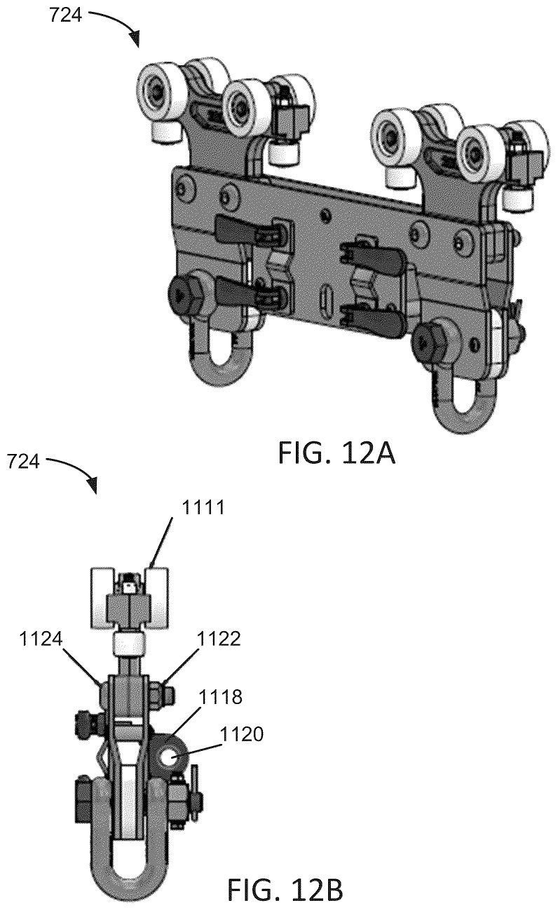

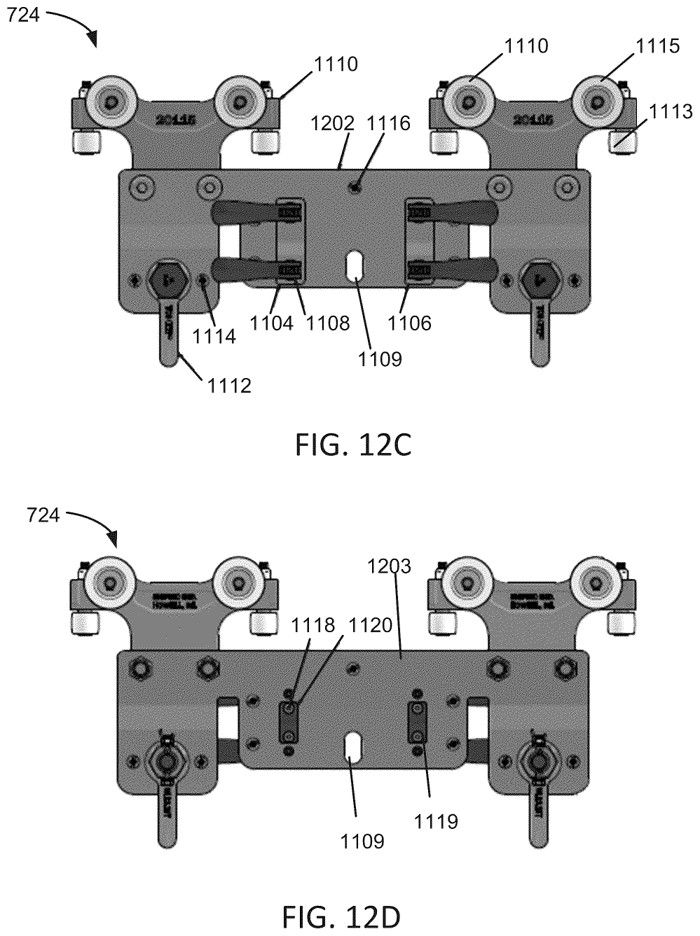

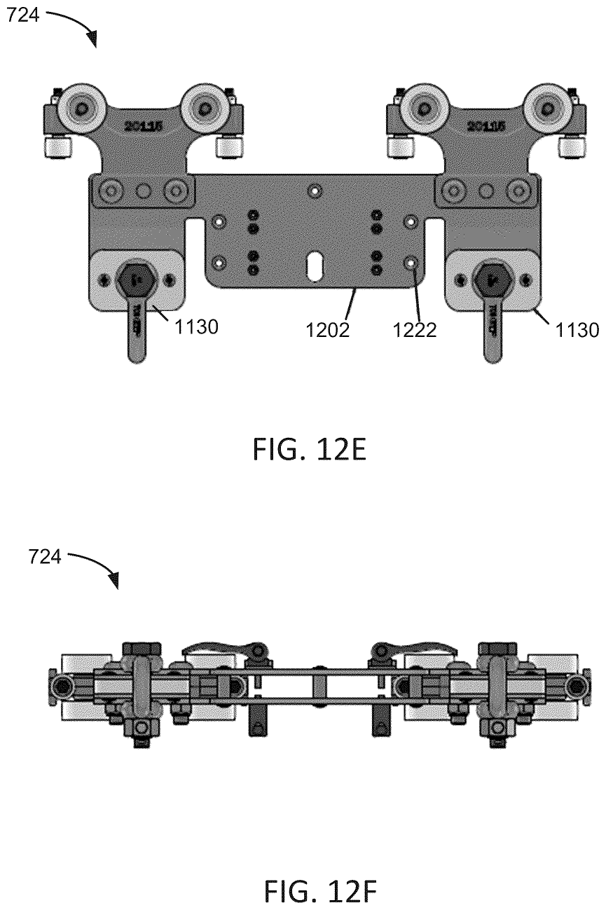

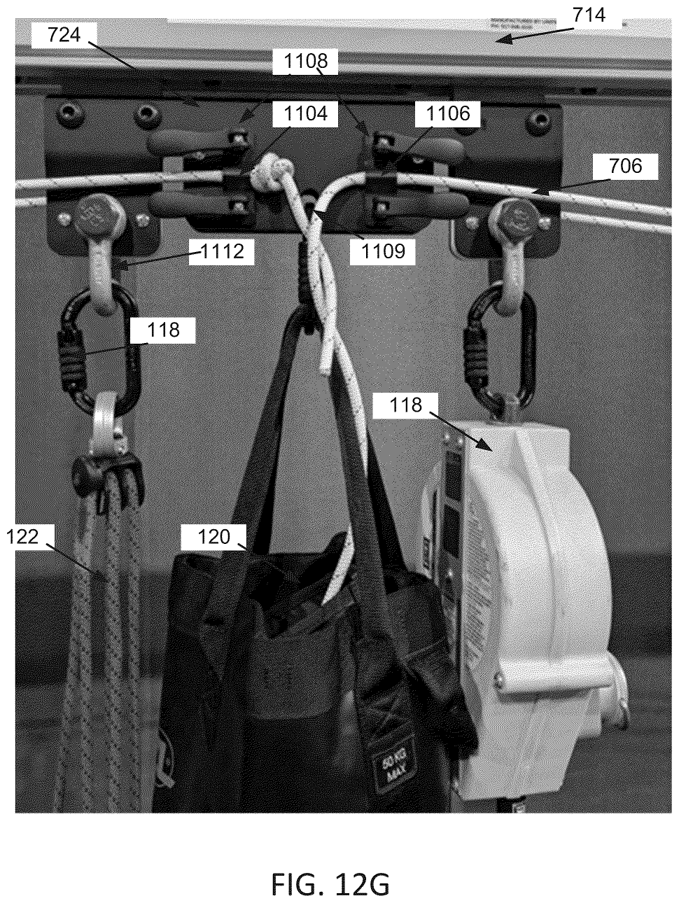

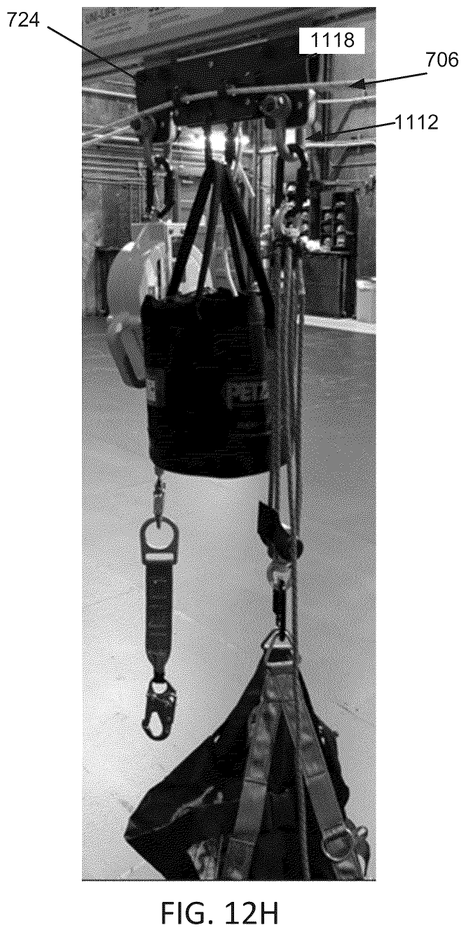

FIG. 12A-12H illustrate various views of the trolley 724. FIGS. 12A, 12G, and 12H illustrate isometric views of the trolley 724. FIGS. 12B-12D illustrates side views of the trolley 724. FIG. 12E illustrates an interior view of the trolley 724. FIG. 12F illustrates a top view of the trolley 724. Trolley 724 includes the same or similar features as trolley 716 and a description of these features is not repeated. Trolley 724 is distinguishable from trolley 716 in that trolley 724 does not include pulleys 1134 and 1139 and spacers 1126 and 1128. As such, the plates 1202 and 1203 of the trolley 724 are more compact in size than that of the plates 1102 and 1103 of the trolley 716.

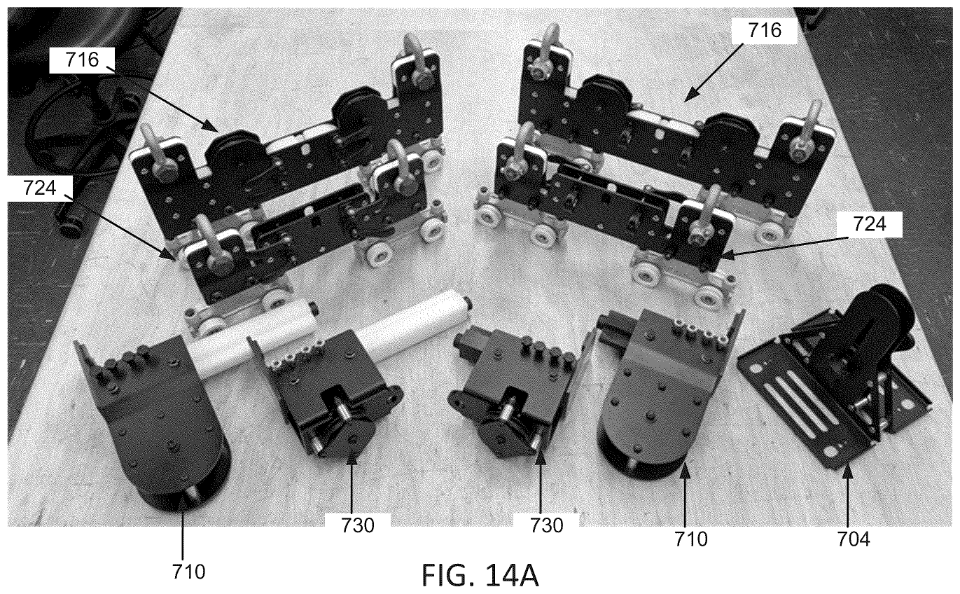

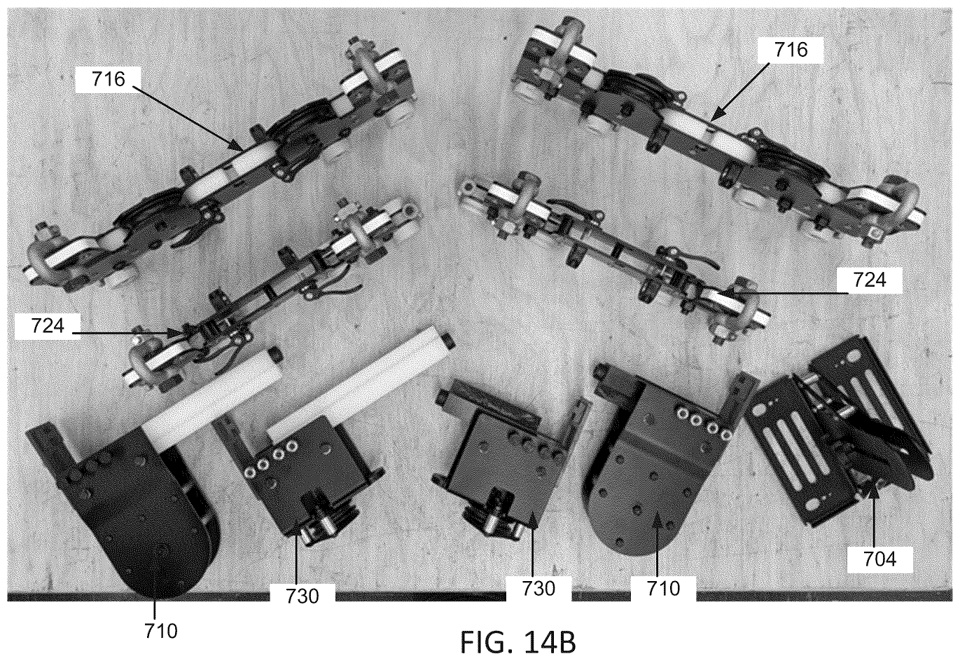

FIGS. 14A and 14B illustrate example parts of an unassembled focus track system 700. For example, the example parts may include, but are not limited to, trolleys 716 and 724, the turndown assembly 710, the turnaround assembly 730, and the floor assembly 704. The parts of the focus track system 700 may be provided in a package, similar to that of package 600. The package may be, for example, but not limited to, a Knaack Box. In some cases, the package also include a tool bag 602 and tools 604 to assemble the system 700.

The various embodiments described above are provided by way of illustration only and should not be construed to limit the claims attached hereto. Those skilled in the art will readily recognize various modifications and changes that may be made without following the example embodiments and applications illustrated and described herein, and without departing from the spirit and scope of the following claims.

What is claimed is:

1. A focus track system, comprising:
a track having a channel disposed along a length of the track;
a first pulley assembly coupled to one end of the track and a second pulley assembly coupled to an opposite end of the track, wherein the first pulley assembly and the second pulley assembly are aligned with one another;
a carrier assembly operably coupled with the first pulley assembly and the second pulley assembly via a first line, wherein the carrier assembly is configured to travel along the length of the channel; and
a focus chair operably coupled to the carrier assembly via a pulley assembly and a second line, such that the focus chair is configured to travel in a direction perpendicular to the length of the track.

2. The focus track system of claim 1, wherein the channel comprises two ledges disposed within a cavity of the track, and wherein the two ledges are spaced apart from one another and extend along the length of the track.

3. The focus track system of claim 2, wherein the carrier assembly comprises a set of wheels sized to travel within the cavity and along the ledges of the channel.

4. The focus track system of claim 1, wherein the channel comprises two ledges that protrude outwards from an exterior of the track, and wherein the carrier assembly comprises a set of wheels sized to travel along the ledges.

5. The focus track system of claim 1, wherein a plurality of couplers are configured to couple the track to a batten via mounting blocks, wherein the mounting blocks are each attached to a respective coupler and disposed within the track.

6. The focus track system of claim 5, wherein a portion of the mounting blocks are disposed within a second channel of the track, such that the mounting blocks are fixed to the track.

7. The focus track system of claim 1, wherein the track is positioned at an elevated height from a floor, wherein the carrier assembly is configured to travel along the length of the channel while the track is elevated from the floor, and wherein the focus chair is configured to travel perpendicular to the length of the track while the track is elevated from the floor.

8. The focus track system of claim 1, wherein the track is coupled to a second track having a second channel that aligns with the channel of the track.

9. The focus track system of claim 1, wherein the first pulley assembly comprises pulleys arranged side-by-side in a vertical position with respect to the track, and wherein the second pulley assembly comprises a pulley arranged in a horizontal position with respect to the track.

10. The focus track system of claim 9, wherein the first pulley assembly comprises a mounting block coupled to a plate that fastens the two pulleys in the vertical position.

11. The focus track system of claim 10, wherein the mounting block is sized to fit within the channel of the track and is spaced apart from the plate.

12. The focus track system of claim 9, wherein the track further comprises an end stop fastened within the track adjacent the second pulley assembly.

13. The focus track system of claim 9, wherein the first line translates about one of the pulleys of the first pulley assembly, translates about the pulley of the second pulley assembly, and translates about another pulley of the first pulley assembly to move the carrier assembly along the length of the channel.

14. The focus track system of claim 13, further comprising a pulley assembly mounted to a floor, wherein the first line translates from one of the pulleys of the first pulley assembly about the floor pulley assembly to the other pulley of the first pulley assembly.

15. The focus track system of claim 1, wherein the carrier assembly comprises at least one pinch plate positioned on one side of the carrier assembly and at least one guide block positioned on an opposite side of the carrier assembly.

16. The focus track system of claim 15, wherein an end of the first line is fixed to the at least one pinch plate, and wherein a portion of the first line translates through the at least one guide block.

17. The focus track system of claim 15, wherein the carrier assembly comprises at least two plates spaced apart from one another, wherein the at least two plates each comprising a protruded section, and wherein the pinch plate is coupled to an exterior surface of one plate and the at least one guide block is coupled to an exterior surface of the other plate.

18. The focus track system of claim 1, wherein the carrier assembly comprises at least two plates spaced apart from one another and a third pulley assembly disposed between the two plates and configured to receive a lifting line that is operably coupled to the focus chair to adjust a height of the focus chair with respect to the track.

19. The focus track system of claim 18, wherein the carrier assembly further comprises at least two spacers positioned in between the at least two plates, and wherein the at least two spacers form a channel to guide the lifting line across the third pulley assembly.

20. A focus track kit, comprising:
a track having a channel disposed along a length of the track;
a first pulley assembly configured to couple to one end of the track and a second pulley assembly configured to couple to an opposite end of the track, wherein the first pulley assembly and the second pulley assembly are aligned with one another when coupled to the track;
a carrier assembly configured to operably couple with the first pulley assembly and the second pulley assembly via a first line, wherein the carrier assembly is configured to travel along the length of the channel; and
a focus chair configured to operably couple to the carrier assembly via a pulley assembly and a second line, such that the focus chair is configured to travel in a direction perpendicular to the length of the track.
